(19) United States
(12) Patent Application Publication
(10) Pub. No.: US 2007/0221563 A1
(43) Pub. Date: Sep. 27, 2007

(54) Nucleic Acid-Adsorbing Porous Membrane for Separating and Purifying Nucleic Acid and Apparatus for Separating and Purifying Nucleic Acid

(75) Inventors: Yoshiki Sakaino, Asaka-shi (JP); Yoshihiko Makino, Asaka-shi (JP); Toshihiro Mori, Asaka-shi (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD., Minami-Ashigara-shi (JP)

(21) Appl. No.: 10/576,418

(22) PCT Filed: Oct. 20, 2004
(86) PCT No.: PCT/JP04/15880

§ 371 Date: Jan. 31, 2007

(30) Foreign Application Priority Data
Oct. 20, 2003 (JP) 2003-359900
Dec. 9, 2003 (JP) 2003-410637

(51) Int. Cl. B01D 63/00

(52) U.S. Cl. 210/257.2; 210/500.21; 210/500.27; 210/500.29; 210/500.3; 210/500.31

(57) ABSTRACT

To provide a nucleic acid-adsorbing porous membrane which has an excellent separating ability, which provides a good washing efficiency, which permits convenient and expeditious procedures, which is adapted for automation and reduction in size, which can be mass produced with substantially identical separating capability, and which is adapted for a method of separating and purifying nucleic acids and to provide an apparatus using the same, a nucleic acid-adsorbing porous membrane for separating and purifying a nucleic acid, comprises a nucleic acid-adsorbing solid phase for use in a method for separating and purifying the nucleic acid, the solid phase adsorbing the nucleic acid, the method comprising the steps of: (1) adsorbing the nucleic acid to the solid phase by allowing a sample solution containing the nucleic acid to come into contact with the nucleic acid-adsorbing solid phase; (2) washing the solid phase by allowing a washing solution to come into contact with the solid phase, while the nucleic acid is adsorbed to the solid phase; and (3) desorbing the nucleic acid from the solid phase by allowing a recovering solution to come into contact with the solid phase.

### TECHNICAL FIELD

The present invention relates to a nucleic acid-adsorbing porous membrane for use in separation and purification of nucleic acid and to an apparatus for separation and purification of nucleic acid using the same. More preferably, it relates to a nucleic acid-adsorbing membrane for separation and purification of nucleic acid from a sample containing nucleic acids using a sample solution containing nucleic acid and using a cartridge for separation and purification of nucleic acid having a nucleic acid-adsorbing porous membrane within a container having at least two openings and a pressure-generating apparatus, and to an apparatus for separation and purification of nucleic acid using the same.

### BACKGROUND ART

Various forms of nucleic acids are used in a variety of fields. For example, in the field of recombinant nucleic acid technology, nucleic acids are used in the form of probes, genomic nucleic acids and plasmid nucleic acids.

In the field of diagnostics, nucleic acids are used in various methods. For example, nucleic acid probes are used routinely in the detection and diagnosis of human pathogen. Likewise, nucleic acids are used in the detection of genetic disorders. Nucleic acids are also used in the detection of food contaminants. Further, nucleic acids are used routinely in locating, identifying and separating nucleic acids of interest for a variety of reasons ranging from genetic mapping to cloning and recombinant expression.

In many cases, nucleic acids are available in extremely small amounts, and thus separation and purification procedures are laborious and time consuming. These often time consuming and laborious operations are likely to lead to the loss of nucleic acids. In purifying nucleic acids from samples obtained from serum, urine and bacterial cultures, there is a risk of contamination and false positive results.

One widely known purification method is a method of adsorbing nucleic acids to surfaces of a solid phase such as silicon dioxide, silica polymers or magnesium silicate, followed by the procedures such as washing and desorbing, to carry out purification (e.g., Patent document 1: JP-B-7-51065). This method exhibits excellent separation ability. However, it is insufficient in handling ease, rapidness, automation adaptability and size reduction adaptability, and industrial mass production of adsorbents with identical performance is difficult. Further, there are other drawbacks, such as inconvenience in handling and difficulty in processing into various shapes.

Also, as a method for separating and purifying nucleic acids with ease and good efficiency, there has been described a method of adsorbing on then desorbing from a solid phase comprising an organic polymer having a hydroxyl group on the surface thereof nucleic acids using a solution for adsorbing nucleic acids on a solid phase and a solution for desorbing the nucleic acids from the solid phase (Patent document 2: JP-A-2003-128691).

On the other hand, as conventional methods for separation and purification of nucleic acid, there are illustrated a centrifuging method, a method of using magnetic beads and a method of using a filter. For example, as an apparatus for separation and purification of nucleic acid using a filter, there has been proposed a mechanism wherein a number of filter tubes containing a filter are set on a rack, a sample solution containing nucleic acids is injected thereinto, a reduced pressure condition is created within the apparatus using an air chamber via a sealing member provided around the bottom of the rack to thereby suck the whole filter tubes from the discharging side and pass the sample solution therethrough, thus nucleic acids being adsorbed on the filter, then a washing solution and a recovering solution are injected in sequence, followed by creating a reduced pressure condition in the same manner to suck, wash and desorb (e.g., Patent document 3: Japanese Patent No. 2,832,586).

However, the conventional methods for separation and purification are still insufficient in yield and purity, and further improvements have been required. Also, conventional automatic apparatuses are large-sized and are adapted for analyzing many samples, but involve the problem that they are expensive and unsuitable in the case where the number of samples and analyzing frequency are small, with processing efficiency being reduced. In particular, in the case where sample solutions have different properties from each other like the collected whole blood samples, an apparatus wherein the whole tubes are sucked at the same time as described in patent document 3. (Japanese Patent No. 2,832,586) involves the problem that, when suction of some filter tubes is completed and therefore the suction resistance is decreased, the pressure-reducing force acting on other filter tubes becomes smaller, leading to possible incompletion of the treatment of a highly viscous sample solution. To increase the pressure-reducing volume causes a problem in reducing the size of the apparatus, and a large pressure-reducing volume requires a time for performing pressure reduction. In addition, it is difficult to detect complete discharge of the solution, and a predetermined period for the analysis is prolonged, thus processing efficiency being injured. Also, with a sample solution having a low viscosity, the solution is discharged from the filter tube so vigorously that foamy splashes deposit to adjacent filter tubes and the rack to cause contamination, thus causing reduction in accuracy of analysis.

### DISCLOSURE OF THE INVENTION

It is, therefore, an object of the invention to provide a nucleic acid-adsorbing solid phase adapted for separating ‘and purifying nucleic acids contained’ in a sample in a high yield with a high purity.

It is another object of the invention to provide a nucleic acid-adsorbing solid phase which has excellent separating capability and good washing efficiency, which permits easy procedure at a high speed, which has excellent adaptability for automation and reduction in size, and which can be mass produced with substantially identical separating capability.

It is another object of the invention to provide an apparatus for separation and purification of nucleic acid, which permits processing in a short time with a good efficiency without generation of contamination and of which size can be reduced.

As a result of intensive investigations to solve the above-described problems, the inventors have found that, in a method for separating and purifying nucleic acids, it is effective to include the steps of adsorbing and desorbing nucleic acids to and from a porous membrane. Therefore, the present invention provides a nucleic acid-adsorbing porous membrane adapted for the method. In particular, it has been found that, in a method for separating and purifying nucleic acids, nucleic acids can be separated in a high yield with a high purity from a sample solution containing nucleic acids, by using as the porous membrane a porous membrane on which nucleic acids are adsorbed through an interaction wherein ionic bond does not participate. The present invention has been completed based on these findings.

That is, the invention has the following constitution.

1. A nucleic acid-adsorbing porous membrane for separating and purifying a nucleic acid, which comprises a nucleic acid-adsorbing solid phase for use in a method for separating and purifying the nucleic acid, the solid phase adsorbing the nucleic acid,

the method comprising the steps of:

(1) adsorbing the nucleic acid to the solid phase by allowing a sample solution containing the nucleic acid to come into contact with the nucleic acid-adsorbing solid phase;

(2) washing the solid phase by allowing a washing solution to come into contact with the solid phase, while the nucleic acid is adsorbed to the solid phase; and

(3) desorbing the nucleic acid from the solid phase by allowing a recovering solution to come into contact with the solid phase.

2. The nucleic acid-adsorbing porous membrane as described in item 1, which has a thickness of 10 μm to 500 μm.

3. The nucleic acid-adsorbing porous membrane as described in any one of items 1 to 2, which has an average pore size of 0.9 to 5.0 μm.

4. The nucleic acid-adsorbing porous membrane as described in any one of items 1 to 3, which has a front surface and a back surface asymmetrical with each other.

5. The nucleic acid-adsorbing porous membrane as described in item 4, wherein the ratio of the largest pore size to the smallest pore size is 2 or more.

6. The nucleic acid-adsorbing porous membrane as described in any one of items 1 to 5, which has a void volume of 50 to 95%.

7. The nucleic acid-adsorbing porous membrane as described in any one of items 1 to 6, which has a bubble point of 0.1 to 10 kgf/cm².

8. The nucleic acid-adsorbing porous membrane as described in any one of items 1 to 7, which has a pressure loss of 0.1 to 100 kPa.

9. The nucleic acid-adsorbing porous membrane as described in any one of items 1 to 8, which allows water to pass therethrough in an amount of 1 to 5000 mL per minute at a temperature of 25° C. under a pressure of 1 kg/cm².

10. The nucleic acid-adsorbing porous membrane as described in any one of items 1 to 9, which adsorbs the nucleic acid in an amount of 0.1 μg or more per mg of the porous membrane.

11. The nucleic acid-adsorbing porous membrane as described in any one of items 1 to 10, which adsorbs the nucleic acid through an interaction involving substantially no ionic bond between the porous membrane and the nucleic acid.

12. The nucleic acid-adsorbing porous membrane as described in item 11, wherein the porous membrane adsorbing the nucleic acid through the interaction involving substantially no ionic bond comprises an organic polymer having a polysaccharide structure.

13. The nucleic acid-adsorbing porous membrane as described, in item 12, wherein the porous membrane adsorbing the nucleic acid and comprising an organic polymer having a polysaccharide structure is a mixture of acetylcelluloses different from each other in acetyl value.

14. The nucleic acid-adsorbing porous membrane as described in item 13, wherein the mixture of acetylcedlluloses different from each other in acetyl value is a mixture of triacetylcellulose and diacetylcelluolse.

15. The nucleic acid-adsorbing porous membrane as described in item 14, wherein the mixture has a triacetylcellulose/diacetylcellulose mixing rate of 99:1 to 1:99 by weight.

16. The nucleic acid-adsorbing porous membrane as described in item 13, wherein the mixture of acetylcedlluloses different from each other in acetyl value is a mixture of triacetylcellulose and monoacetylcelluolse.

17. The nucleic acid-adsorbing porous membrane as described in item 13, wherein the mixture of acetylcedlluloses different from each other in acetyl value is a mixture of triacetylcellulose, diacetylcellulose and monoacetylcelluolse.

18. The nucleic acid-adsorbing porous membrane as described in item 13, wherein the mixture of acetylcedlluloses different from each other in acetyl value is a mixture of diacetylcellulose and monoacetylcelluolse.

19. The nucleic acid-adsorbing porous membrane as described in item 12, wherein the porous membrane comprising the polymer having the polysaccharide structure is a porous membrane comprising an organic material obtained by saponification of acetylcellulose or acetylcelluloses.

20. The nucleic acid-adsorbing porous membrane as described in item 19, wherein saponification ratio of the acetylcellulose(s) is 5% or more.

21. The nucleic acid-adsorbing porous membrane as described in item 20, wherein the porous membrane comprising the organic material obtained by saponification of the acetylcellulose(s) is a porous membrane comprising an organic material obtained by saponification of a mixture of acetylcelluloses different from each other in acetyl value.

22. The nucleic acid-adsorbing porous membrane as described in item 21, wherein the mixture of acetylcelluloses different from each other in acetyl value has a saponification ratio of 5% or more.

23. The nucleic acid-adsorbing porous membrane as described in item 21 or 22, wherein the organic material obtained by saponification of a mixture of acetylcelluloses different from each other in acetyl value is a saponification product of a mixture of triacetylcellulose and diacetylcellulose.

24. The nucleic acid-adsorbing porous membrane as described in item 23, wherein the triacetylcellulose/diacetylcellulose mixing ratio is 99:1 to 1:99 by weight.

25. The nucleic acid-adsorbing porous membrane as described in item 21 or 22, wherein the organic material obtained by saponification of a mixture of acetylcelluloses different from each other in acetyl value is a saponification product of a mixture of triacetylcellulose and monoacetylcellulose.

26. The nucleic acid-adsorbing porous membrane as described in item 21 or 22, wherein the organic material obtained by saponification of a mixture of acetylcelluloses different from each other in acetyl value is a saponification product of a mixture of triacetylcellulose, diacetylcellulose and monoacetylcellulose.

27. The nucleic acid-adsorbing porous membrane as described in item 21 or 22, wherein the organic material obtained by saponification of a mixture of acetylcelluloses different from each other in acetyl value is a saponification product of a mixture of diacetylcellulose and monoacetylcellulose.

28. The nucleic acid-adsorbing porous membrane as described in any one of items 19 to 27, wherein the average pore size after saponification is reduced to that before saponification.

29. The nucleic acid-adsorbing porous membrane as described in item 28, wherein the ratio of the average pore size after saponification to that before saponification is 0.8 or less.

30. The nucleic acid-adsorbing porous membrane as described in item 12, wherein the organic polymer having a polysaccharide structure is a regenerated cellulose.

31. The nucleic acid-adsorbing porous membrane as described in item 11, wherein the porous membrane adsorbing the nucleic acid through the interaction involving substantially no ionic bond is a porous membrane obtained by treatment of a porous membrane of a hydrophilic group-free organic material so as to introduce a hydrophilic group into the porous membrane.

32. The nucleic acid-adsorbing porous membrane as described in item 31, wherein the treatment of the porous membrane of a hydrophilic group-free organic material comprises binding to the porous membrane, a graft polymer chain having a hydrophilic group in the polymer chain or side chain thereof.

33. The nucleic acid-adsorbing porous membrane as described in item 11, wherein the porous membrane adsorbing the nucleic acid through the interaction involving substantially no ionic bond is a porous membrane obtained by coating a porous membrane of a hydrophilic group-free organic material with a material having a hydrophilic group to thereby introduce a hydrophilic group into the porous membrane.

34. The nucleic acid-adsorbing porous membrane as described in item 33, wherein the material having a hydrophilic group is an organic polymer having a hydrophilic group in the polymer chain or the side chain thereof.

35. The nucleic acid-adsorbing porous membrane as described in item 11, wherein the porous membrane adsorbing the nucleic acid through the interaction involving substantially no ionic bond is an inorganic material where a material for forming the porous membrane itself has a hydrophilic group.

36. The nucleic acid-adsorbing porous membrane as described in item 11, wherein the porous membrane adsorbing the nucleic acid through the interaction involving substantially no ionic bond is a porous membrane obtained by treatment of a porous membrane of a hydrophilic group-free inorganic material so as to introduce a hydrophilic group into the porous membrane.

37. The nucleic acid-adsorbing porous membrane as described in item 36, wherein the treatment for introducing the hydrophilic group into the hydrophilic group-free inorganic material comprises binding to the porous membrane, a graft polymer chain having a hydrophilic group in the polymer chain or side chain thereof.

38. The nucleic acid-adsorbing porous membrane as described in item 11, wherein the porous membrane adsorbing the nucleic acid through the interaction involving substantially no ionic bond is a porous membrane obtained by coating a porous membrane of a hydrophilic group-free inorganic material with a material having a hydrophilic group to thereby introduce a hydrophilic group into the porous membrane.

39. The nucleic acid-adsorbing porous membrane as described in item 38, wherein the material having a hydrophilic group is an organic polymer having a hydrophilic group in the polymer chain or side chain thereof.

40. The nucleic acid-adsorbing porous membrane as described in any one of items 31 to 39, wherein the hydrophilic group is a hydroxyl group.

41. The nucleic acid-adsorbing porous membrane as described in any one of items 1 to 40, wherein the sample solution containing the nucleic acid, the washing solution and the recovering solution are passed, in the step (1), step (2) and step (3), respectively, through the nucleic acid-adsorbing porous membrane under pressure.

42. The nucleic acid-adsorbing porous membrane as described in item 41, which is used in the method for separating and purification the nucleic acid,

wherein the sample solution containing the nucleic acid, the washing solution and the recovering solution is injected, in the step (1), step (2) and step (3), respectively, through a first opening of a cartridge for separating and purifying the nucleic acid, in which the cartridge comprises at least two openings including the first opening and a second opening; and

inside of the cartridge is made in a pressurized state with a pressure difference-generating apparatus attached to the first opening, so as to pass each of the sample solution containing the nucleic acid, the washing solution and the recovering solution through the porous membrane and to discharge each of the sample solution containing the nucleic acid, the washing solution and the recovering solution from the second opening.

43. A cartridge for separation and purification of nucleic acid, which comprises: a container including at least two openings including a first opening and a second opening; and a nucleic acid-adsorbing porous membrane described in any one of items 1 to 42, the porous membrane being received (or accommodated) in the container.

44. The cartridge for separation and purification of nucleic acid as described in item 43, wherein a pump as a pressure difference-generating apparatus is removably attached to the first opening of the cartridge for separation and purification of nucleic acid.

45. A kit comprising: a cartridge for separation and purification of nucleic acid, the cartridge accommodating a nucleic acid-adsorbing porous membrane described in any one of items 1 to 42; and a reagent.

46. An apparatus for separation and purification of nucleic acid, which uses a nucleic acid-adsorbing porous membrane described in any one of items 1 to 42.

47. The apparatus for separation and purification of nucleic acid as described in item 46, which is an automated apparatus automatically carrying out steps of separation and purification of nucleic acid, the steps including: adsorbing a nucleic acid in a sample solution to the nucleic acid-adsorbing porous membrane by injecting the sample solution containing the nucleic acid into a cartridge for separation and purification of nucleic acid, the cartridge comprising the nucleic acid-adsorbing porous membrane, under pressure; injecting a washing solution into the cartridge for separation and purification of nucleic acid under pressure to remove other ingredients than the nucleic acid, while the nucleic acid is adsorbed to the nucleic acid-adsorbing porous membrane; and injecting a recovering solution into the cartridge for separation and purification of nucleic acid under pressure, to desorb the nucleic acid adsorbed to the nucleic acid-adsorbing porous membrane and recover the nucleic acid together with the recovering solution;

wherein the apparatus comprises:

a mechanism of holding: the cartridge for separation and purification of nucleic acid; a waste liquor container for containing a discharged solution of the sample solution and the washing solution; and a recovery container for containing the recovering solution containing the nucleic acid;

a mechanism of feeding a pressure air into the cartridge for separation and purification of nucleic acid; and

a mechanism of separately injecting the washing solution and the recovering solution into the cartridge for separation and purification of nucleic acid.

48. The apparatus for separation and purification of nucleic acid as described in item 47, wherein the holding mechanism comprises: a stand mounted on a body of the apparatus; a cartridge holder vertically movably supported on the stand and holding the cartridge for separation and purification of nucleic acid; and a holder for holding the waste liquor container and the recovering container at a position below the cartridge holder so that the relative position with respect to the cartridge can be exchanged.

49. The apparatus for separation and purification of nucleic acid as described in item 47 or 48, wherein the pressure air-feeding mechanism comprise: an air nozzle for jetting pressure air from the lower edge portion; a pressure head for supporting and vertically moving the air nozzle with respect to the cartridge for separation and purification of nucleic acid held in the cartridge holder; and a positioning means provided on the pressure head, the positioning means being for positioning the cartridge for separation and purification of nucleic acid in a rack of the holding mechanism.

50. The apparatus for separation and purification of nucleic acid as described in any one of items 47 to 49, wherein the separately injecting mechanism comprises: a washing solution-injecting nozzle for injecting the washing solution; a recovering solution-injecting nozzle for injecting the recovering solution; a nozzle-shifting rack holding the washing solution-injecting nozzle and the recovering solution-injecting nozzle and capable of migrating in sequence over the cartridges for separation and purification of nucleic acid held by the holding mechanism; a washing solution-feeding pump for sucking the washing solution from a bottle containing the washing solution and feeding the washing solution to the washing solution-injecting nozzle; and a recovering solution-feeding pump for sucking the recovering solution from a bottle containing the recovering solution and feeding the recovering solution to the recovering solution-feeding nozzle.

Nucleic acids can be separated and purified with a high efficiency and a high purity by using the nucleic acid-adsorbing porous membrane of the invention, adsorbing nucleic acids contained in a sample on the porous membrane, washing the porous membrane, then desorbing the nucleic acids. Further, the method for separation and purification of nucleic acid using the nucleic acid-adsorbing porous membrane of the invention can be conducted with an excellent separating capability, good convenience and prompt efficiency, has excellent adaptability for automation and size reduction, and the porous membrane can be mass produced with substantially identical separating capability.

Further, the present invention can provide an apparatus for separation and purification of nucleic acid which enables one to conduct the procedures in a short time with good efficiency without causing contamination, and which can be made in a smaller size.

### BRIEF DESCRIPTION OF DRAWINGS

FIG. 1 is a perspective view showing one embodiment of the invention of an apparatus for separating and purifying nucleic acids with the cover being removed.

FIG. 2 shows a schematic diagram of an automatic apparatus.

FIG. 3 is a perspective view of a rack in a holding mechanism.

FIG. 4 is a perspective view showing a rack under operation.

FIG. 5 is a flow sheet showing the stages of separating and purifying nucleic acids.

FIG. 6 is a perspective view showing a cartridge for separation and purification of nucleic acid.

FIG. 7 shows the resulting photograph of electrophoresis of nucleic acids separated and purified from a sample solution containing nucleic acids according to the embodiment of the invention.

FIG. 8 shows the resulting photograph of electrophoresis of nucleic acids separated and purified from a sample solution containing nucleic acids according to the embodiment of the invention.

FIG. 9 shows the resulting photograph of electrophoresis of nucleic acids separated and purified from a sample solution containing nucleic acids according to the embodiment of the invention.

In figures, 1 indicates automatic apparatus, 2 indicates body of the apparatus, 3 indicates holding mechanism, 4 indicates pressure air-feeding mechanism, 5 indicates solution-injecting mechanism or separately injecting mechanism, 6 indicates rack, 11 indicates cartridge for separation and purification of nucleic acid, 11b indicates nucleic acid-adsorbing porous membrane, 12 indicates waste liquor container, 13 indicates recovering container, 40 indicates pressure head, 41 indicates air nozzle, 43 indicates air pump, 45 indicates on-off valve, 46 indicates pressure sensor, 49 indicates pressing pin (positioning means), 50 indicates nozzle-shifting rack, 51w or 51r indicates injecting nozzle, 52w or 52r indicates feeding pump, 56w or 56r indicates bottle, 61 indicates stand, 62 indicates cartridge holder, 63 indicates container holder, S indicates sample solution, W indicates washing solution, and R indicates recovering solution.

### BEST MODE FOR CARRYING OUT THE INVENTION

The method for separation and purification of nucleic acid using the nucleic acid-adsorbing porous membrane of the invention includes at least the steps of:
(1) adsorbing a nucleic acid to the nucleic acid-adsorbing porous membrane by passing a sample solution containing nucleic acids through the nucleic acid-adsorbing porous membrane;
(2) washing the nucleic acid-adsorbing porous membrane with the nucleic acid being adsorbed thereon; and
(3) desorbing the nucleic acid from the nucleic acid-adsorbing porous membrane by passing a recovering solution therethrough.

Preferably, in the steps (1), (2) and (3), the sample solution containing nucleic acids, the washing solution and the recovering solution are passed through the nucleic acid-adsorbing porous membrane under pressure.

More preferably, in the steps (1), (2) and (3), the sample solution containing nucleic acids, the washing solution and the recovering solution are respectively injected in one opening of a cartridge for separation and purification of nucleic acid comprising a container having at least two openings and the nucleic acid-adsorbing porous membrane, and an increased pressure condition is created in the cartridge by a pressure difference-generating apparatus connected to said one opening of the cartridge to thereby pass each injected solution and discharge out of the other opening. The apparatus can be automated in a compact form by passing the sample solution containing nucleic acids, the washing solution and the recovering solution through the porous membrane under pressure, thus such technique being preferred. The pressure to be applied is preferably from about 10 to about 200 kpa, more preferably from about 40 to about 100 kpa.

In the steps for separation and purification described above, the procedures from the first step of injection of a sample solution containing nucleic acids to the step of obtaining a nucleic acid outside the cartridge for separation and purification of nucleic acid can be completed within 10 minutes or, under preferred conditions, within 2 minutes. Also, the above-described steps for separation and purification of nucleic acid enables one to obtain nucleic acids in a yield of 50% by weight or more or, under preferred conditions, 90% by weight or more, based on the amount of whole nucleic acids contained in the sample.

Also, the above-described steps for separation and purification of nucleic acid enables one to recover nucleic acids having a molecular weight widely ranging from 1 kbp to 200 kbp, particularly from 20 kbp to 140 kbp. That is, in comparison with the conventionally employed spin column method using a glass filter, a longer chained nucleic acid can be recovered.

Also, the above-described steps for separation and purification of nucleic acid enables one to recover a nucleic acid having a purity of from 1.6 to 2.0 with respect to DNA, or from 1.8 to 2.2 with respect to RNA, in terms of values measured by means of a spectrophotometer for UV light to visible light (260 nm/280 nm). Thus, a nucleic acid with less contamination and high purity can constantly be obtained. Further, DNA having a high purity of approximately 1.8 in the value measured by means of the spectrophotometer for UV light to visible light (260 nm/280 nm) and RNA having a high purity of approximately 2.0 can be recovered.

Examples of the pressure difference-generating apparatus to be used in the above-described steps include a syringe, a pipette, an increased pressure-generating pump such as Perista pump, and a reduced pressure generator such as an evaporator. Among these, a syringe is appropriate for manual operation, and a pump is appropriate for automated operation. Also, a pipette has the advantage that it can be operated one-handed. Preferably, the pressure difference-generating apparatus is detachably connected to one opening of the cartridge for separation and purification of nucleic acid.

There is no limit on the samples which can be used in the invention, but examples thereof in the field of diagnostics include body fluids collected as samples, such as whole blood, plasma, serum, urine, stool, sperm, and saliva, or plants (or a part thereof), animals (or a part thereof), bacteria, viruses, cultured cells, and solutions prepared from biological materials such as lysates and homogenates of the above-mentioned samples.

First, these samples are treated with an aqueous solution containing a reagent which dissolves cell membranes and solubilizes nucleic acids (nucleic acid-solubilizing reagent). This enables cell membranes and nuclear membranes to be dissolved, and enables nucleic acids to be dispersed into the aqueous solution, thus a sample solution containing nucleic acids being obtained.

For dissolving cell membranes and solubilizing nucleic acids, for example, when a sample is whole blood, (1) removal of erythrocytes, (2) removal of various proteins, and (3) lysis of leukocytes and nuclear membrane, are necessary. (1) Removal of erythrocytes and (2) removal of various proteins are necessary to prevent their non-specific adsorption to the porous membrane and clogging of the porous membrane, and (3) lysis of leukocytes and nuclear membranes is necessary to solubilize nucleic acids which are to be extracted. In particular, (3) lysis of leukocytes and nuclear membranes is an important process and, in the method of the invention, nucleic acids are required to be solubilized in this process.

The nucleic acid-containing sample may be a sample containing a single nucleic acid, or may be a sample containing different, plural kinds of nucleic acids. Nucleic acids to be recovered are not limited as to kind, and may be DNA or RNA, single-stranded chain or double-stranded chain, and straight or cyclic. The number of samples may be one or plural (parallel treatment of plural samples using plural vessels). The length of nucleic acid to be recovered is not particularly limited, either, and a nucleic acid of any length between, for example, from several bp to several Mbp can be used. In view of handling convenience, the length of a nucleic acid to be recovered is generally from about several bp to about several hundreds kbp. The method of the invention for separation and purification of nucleic acid enables one to recover a comparatively longer nucleic acid expeditiously than that obtained by the conventional simple method for separation and purification of nucleic acid, and can be employed for recovering a nucleic acid of preferably 50 kbp or more, more preferably 70 kbp or more, still more preferably 100 kbp or more. In view of recovering a longer DNA, it is preferable to conduct stirring and pipetting mildly.

A step of obtaining a sample solution containing nucleic acids from a sample by lysis of cell membrane and nuclear membrane to thereby solubilize nucleic acids is described below. In the invention, a nucleic acid-solubilizing reagent is used for solubilizing nucleic acid by lysis of cell membrane and nuclear membrane. Examples of the nucleic acid-solubilizing reagent include solutions containing a chaotropic salt, a surfactant or a protease.

As a method for obtaining a sample solution containing nucleic acids from a sample by lysis of cell membrane and nuclear membrane to thereby solubilize nucleic acids, there is illustrated a method including the steps of:
(I) injecting a sample containing cells or viruses into a container;
(II) adding a nucleic acid-solubilizing reagent solution containing a chaotropic salt or a surfactant to the container, and mixing the sample with the nucleic acid-solubilizing reagent solution;
(III) incubating the resultant mixed solution; and
(IV) adding a water-soluble organic solvent to the incubated mixed solution.

In the step of obtaining a sample solution containing nucleic acids from a sample by lysis of cell membrane and nuclear membrane to thereby solubilize nucleic acids, adaptability for automated processing is improved by subjecting the sample to homogenizing treatment. Such homogenizing treatment can be conducted, for example, by ultrasonic wave treatment, treatment using a sharp projection, high-speed stirring treatment, treatment of extruding through fine pores or treatment using glass beads.

Also, in the step of obtaining a sample solution containing nucleic acids from a sample by lysis of cell membrane and nuclear membrane to thereby solubilize nucleic acids, the recovering amount and recovering yield of nucleic acid can be improved by using a nucleic acid-solubilizing reagent containing a protease, thus reduction of the necessary amount of a sample containing nucleic acids and acceleration of the analysis becoming possible.

As such protease, at least one protease selected from among serine protease, cysteine protease, metal protease, etc. can preferably be used. Also, a mixture of plural kinds of proteases may preferably be used.

Serine protease is not particularly limited and, for example, protease K can preferably be used. Cysteine protease is not particularly limited and, for example, papain and cathepsin may preferably be used.

Metal protease is not particularly limited and, for example, carboxypeptidase may preferably be used.

The protease can be used, upon addition, in an amount of preferably from 0.001 IU to 10 IU, more preferably from 0.01 IU to 1 IU, per ml of the whole reaction system.

Also, as the protease, a protease not containing nuclease can preferably be used. Also, a protease containing a stabilizing agent can preferably be used. As the stabilizing agent, a metal ion can preferably be used. Specifically, magnesium ion is preferable, and can be added in the form of, for example, magnesium chloride. Incorporation of a stabilizing agent for a protease enables one to reduce the amount of protease necessary for recovery of nucleic acids to a slight amount, which serves to reduce the cost required for recovery of nucleic acids. The amount of the stabilizing agent for protease is preferably from 1 to 1000 mM, more preferably from 10 to 100 mM, based on the whole amount of the reaction system.

The protease may be used as one reagent obtained by previously mixing with other reagents such as a chaotropic salt and a surfactant, thus being used for recovery of nucleic acids.

Alternatively, the protease may be used as a separate reagent from other reagents such as a chaotropic salt and a surfactant.

In the latter case, a sample is first mixed with a reagent containing a protease, and the mixture is then mixed with a reagent containing a chaotropic salt and a surfactant. Or, the protease may be mixed after first mixing a sample with the reagent containing a chaotropic acid and a surfactant.

Also, it is possible to dropwise add from a container retaining a protease directly like an eye lotion to a sample or a mixture of a sample and a reagent containing a chaotropic salt and a surfactant. In this case, operation can be simplified.

The nucleic acid-solubilizing reagent may preferably be fed in a dry state as well. Also, a container previously containing a protease in a dried state, for example, by freeze-drying can be used. It is also possible to obtain a sample solution containing nucleic acid by using both the nucleic acid-solubilizing reagent to be fed in a dry state and a container previously containing a dried protease.

In the case of obtaining a sample solution containing nucleic acids by the above-described method, the nucleic acid-solubilizing reagent and the protease acquire a good storage stability, and the operation can be simplified without changing yields of nucleic acids.

The method for mixing a sample and the nucleic acid-solubilizing reagent solution is not particularly limited.

Upon mixing, it is preferable to mix at 30 to 3000 rpm for 3 minutes using a stirrer, whereby the yield of nucleic acid separated and purified can be increased. Also, it is also preferable to mix by conducting end-over-end mixing 5 to 30 times. Also, mixing can be conducted by repeating pipetting operation 10 to 50 times. In this case, the yields of separated and purified nucleic acids can be increased by simple operation.

The yields of separated and purified nucleic acids can be increased by incubating the mixture of a sample and a nucleic acid-solubilizing reagent solution at an optimal temperature for a protease for an optimal reaction time. The incubation temperature is usually from 20° C. to 70° C., preferably an optimal temperature for the protease, and the incubation time is usually from 1 to 90 minutes, preferably an optimal incubation time for the protease. The incubation method is not particularly limited, and can be conducted by dipping into a warm bath or a heating chamber.

In the step of obtaining a sample solution containing nucleic acids from a sample by lysis of cell membrane and nuclear membrane to thereby solubilize nucleic acids, the nucleic acid-solubilizing reagent solution has a pH of preferably 5 to 10, more preferably 6 to 9, still more preferably 7 to 8.

Also, in the step of obtaining a sample solution containing nucleic acids from a sample by lysis of cell membrane and nuclear membrane to thereby solubilize nucleic acids, the concentration of a chaotropic salt in the nucleic acid-solubilizing reagent solution is preferably 0.5 M or more, more preferably 0.5 M to 4 M, still more preferably 1 M to 3 M. As the chaotropic salt, guanidine hydrochloride is preferred, but other chaotropic salts (e.g., guanidine isothiocyanate and guanidine thiocyanate) may also be used. Instead of a chaotropic salt, it is also possible to use urea as a chaotropic substance. These salts may be used independently or in combination of two or more thereof.

The nucleic acid-solubilizing reagent solution may contain a water-soluble organic solvent. As the water-soluble organic solvent, alcohols are preferred. The alcohols may be any of primary alcohols, secondary alcohols and tertiary alcohols. As the alcohol, methyl alcohol, ethyl alcohol, propyl alcohol and its isomers, and butyl alcohol and its isomers may preferably be used. These water-soluble organic solvents may be used independently or as a combination of two or more thereof. The concentration of the water-soluble organic solvent in the nucleic acid-solubilizing reagent solution is preferably from 1 to 20% by weight.

Also, in the step of obtaining a sample solution containing nucleic acids from a sample by lysis of cell membrane and nuclear membrane to thereby solubilize nucleic acids, examples of the surfactant to be mixed with a sample include nonionic surfactants, cationic surfactants, anionic surfactants and amphoteric surfactants.

In the invention, nonionic surfactants can preferably be used. As the nonionic surfactant, polyoxyethylene alkylphenyl ether series surfactants, polyoxyethykene alkyl ether series surfactants, and fatty acid alkylamides can be used, with polyoxyethylene alkyl ether series surfactants being preferably usable. More preferable are polyoxyethylene alkyl ether series surfactants selected from among POE decyl ether, POE lauryl ether, POE tridecyl ether, POE alkylene decyl ether, POE sorbitan monolaurate, POE sorbitan monooleate, POE sorbitan monostearate, tetraoleic acid polyoxyethyolene sorbitol, POE alkylamine and POE acetylene glycol.

Also, cationic surfactants can also be preferably used. More preferred cationic surfactants are cationic surfactants selected from among cetyltrimethylammonium bromide, dodecyltrimethylammonium chloride, tetradecyltrimethylammonium chloride and cetylpyridinium chloride. These surfactants may be used independently or as a combination of two or more thereof.

The concentration of the surfactant in the nucleic acid-solubilizing reagent solution is preferably from 0.1 to 20% by weight.

In the case of recovering other nucleic acids than RNA, such as DNA, it is preferable to add an RNA-decomposing enzyme to a nucleic acid-solubilizing reagent solution in the step of obtaining a sample solution containing nucleic acids from a sample by lysis of cell membrane and nuclear membrane to thereby solubilize nucleic acids. Thus, interference by RNA otherwise co-present in the recovered nucleic acids can be reduced. It is also preferable to add DNA-decomposing enzyme inhibitor.

On the other hand, in the case of recovering other nucleic acids than DNA, such as RNA, it is preferable to add a DNA-decomposing enzyme to the nucleic acid-solubilizing reagent solution. Thus, interference by DNA otherwise co-present in the recovered nucleic acids can be reduced. It is also preferable to add RNA-decomposing enzyme inhibitor. As the RNA-decomposing enzyme inhibitor, those which specifically inhibit RNA-decomposing enzymes are preferred.

RNA decomposing enzymes are not particularly limited, and enzymes capable of specifically decomposing RNA, such as ribonuclease H (RNase H), can preferably be used.

DNA decomposing enzymes are not particularly limited, and enzymes capable of specifically decomposing DNA, such as DNase I can preferably be used.

The nuclease and the inhibitor of the nuclease can be used in a commonly employed concentration. Also, heating treatment can be conducted. Such heating treatment is preferably conducted simultaneously with the treatment with the protease.

In the step of obtaining a sample solution containing nucleic acids from a sample by lysis of cell membrane and nuclear membrane to thereby solubilize nucleic acids, the sample solution containing nucleic acids may preferably contain a defoaming agent. Preferred examples of the defoaming agent include two types of silicon-containing defoaming agents and alcohol series defoaming agents. As the alcohol series defoaming agents, acetylene glycol series surfactants are preferable.

Specific examples of the defoaming agent include silicon-containing defoaming agents (e.g., silicone oil, dimethylpolysiloxane, silicone emulsion, modified polysiloxane and silicone compound), alcohol series defoaming agents (e.g., acetylene glycol, heptanol, ethylhexanol, higher alcohol and polyoxyalkylene glycol), ether series defoaming agents (e.g., heptyl cellosolve and nonyl cellosolve-3-heptylsorbitol)i fat-and-oil series defoaming agents (e.g., animal oils and plant oils), fatty acid series defoaming agents (e.g., stearic acid, oleic acid and palmitic acid), metallic soap series defoaming agents (e.g., aluminum stearate and calcium stearate), fatty acid ester series defoaming agents (e.g., natural wax and tributyl phosphate), phosphate series defoaming agents (e.g., sodium octylphosphate), amine series defoaming agents (e.g., diamylamine), amide series defoaming agents (e.g., stearic acid amide) and other defoaming agents (e.g., ferric sulfate and bauxite). Particularly preferably, a combination of a silicon-containing defoaming agent and an alcohol series defoaming agent can be used as the defoaming agent. Also, as the alcohol series defoaming agent, an acetylene glycol series surfactant can preferably be used.

Also, in the step of obtaining a sample solution containing nucleic acids from a sample by lysis of cell membrane and nuclear membrane to thereby solubilize nucleic acids, the resultant sample solution containing nucleic acids has a surface tension of preferably 0.050 J/m² or less, a viscosity of preferably from 1 to 10000 mPa, and a specific gravity of preferably from 0.8 to 1.2.

In the step of obtaining a sample solution containing nucleic acids from a sample by lysis of cell membrane and nuclear membrane to thereby solubilize nucleic acids, an alcohol can preferably be used as a water-soluble organic solvent to be added to an incubased mixed solution. As the alcohol, any of a primary alcohol, a secondary alcohol and a tertiary alcohol may be used. Methyl alcohol, ethyl alcohol, propyl alcohol, butyl alcohol, and an isomer thereof can preferably be used. The final concentration of such water-soluble organic solvent in the sample solution containing nucleic acids is preferably from 5 to 90% by weight.

The nucleic acid-adsorbing porous membrane to be used in the invention and the adsorbing step are described below.

The nucleic acid-adsorbing porous membrane of the invention enables a solution to pass through the inside thereof. Here, the term “enable a solution to pass through the inside thereof” means that, when a pressure difference is generated between a space in contact with one side of the membrane and a space in contact with another side of the membrane, a solution is allowed to pass through the inside of the membrane from the high-pressure space to the low-pressure space or means that, when a centrifugal force is applied to the membrane, a solution is allowed to pass thorough the inside of the membrane in the centrifugal direction.

The nucleic acid-adsorbing porous membrane of the invention is preferably a porous membrane to which nucleic acids adsorb based on an interaction wherein ion bond does not substantially participate. This means that no “ionization” takes place under the condition of using the porous membrane, and it is surmised that nucleic acids and the porous membrane pull against each other due to change in surrounding polarity. Thus, nucleic acids can be separated and purified with excellent separating performance and good washing efficiency. Preferably, the nucleic acid-adsorbing porous membrane is a porous membrane having a hydrophilic group, and it is surmised that hydrophilic group of nucleic acids and hydrophilic group of the porous membrane come to pull against each other when the surrounding polarity is changed. Here, the term “porous membrane having a hydrophilic group” means a porous membrane wherein the material constituting the porous membrane itself has the hydrophilic group, or a porous membrane obtained by treating or coating a porous membrane-constituting material in order to introduce the hydrophilic group into the porous membrane. The porous membrane-constituting material may be an organic or inorganic material. For example, there may be used a porous membrane wherein the porous membrane-constituting material itself is an organic material having a hydrophilic group, a porous membrane which is obtained by treating a porous membrane made of a hydrophilic group-free organic material so as to introduce the hydrophilic group thereinto, a porous membrane obtained by coating a porous membrane made of a hydrophilic group-free organic material with a material having a hydrophilic group to thereby introduce the hydrophilic group, a porous membrane wherein the porous membrane-constituting material itself is an inorganic material having a hydrophilic group, a porous membrane which is obtained by treating a porous membrane made of a hydrophilic group-free inorganic material so as to introduce the hydrophilic group thereinto, and a porous membrane obtained by coating a porous membrane made of a hydrophilic group-free inorganic material with a material having a hydrophilic group to thereby introduce the hydrophilic group. In view of processing ease, it is preferable to use an organic material such as an organic polymer as the material for constituting the porous membrane.

The hydrophilic group means a polar group (atoms) capable of exerting an interaction with water, and includes all groups (atoms) participating in adsorption of nucleic acid. As the hydrophilic group, those which exhibit about a middle level of interaction with water (see, “group having not so strong hydrophilicity” in the item of “hydrophilic group” described in Kagaku Dai-jiten, published by Kyoritsu Shuppan) are preferred, and examples thereof include a hydroxyl group, a carboxyl group, a cyano group and a hydroxyethyl group, with a hydroxyl group being preferred.

Examples of the porous membrane of an organic material having a hydroxyl group include porous membranes formed by polyhydroxyethyl acrylate, polyhydroxyethyl methacrylate, polyvinyl alcohol, polyvinyl pyrrolidone, polyacrylic acid, polymethacryloic acid, polyoxyethylene, acetylcellulose or a mixture of acetylcelluloses different in acetyl value. In particular, a porous membrane of an organic material having a polysaccharide structure can preferably be used.

As the organic material having a polysaccharide structure, cellulose, hemicellulose, dextran, amylase, amylopectin, starch, glycogen, pullulan, mannan, glucomannan, lichenan, isolichenan, laminaran, carrageenan, xylan, fructan, alginic acid, hyaluronic acid, chondroitin, chitin and chitosan can preferably be used. However, these are not limitative, and any organic material having a polysaccharide structure or its derivative may be used. Also, an ester derivative of any of these polysaccharides can preferably be used. Further, a saponification product of the ester derivative of any of these polysaccharides can preferably be used.

As the ester of the ester derivative of any of the above-mentioned polysaccharides, one or more members selected from among carboxylates, nitrates, sulfates, sulfonates, phosphates, phosphonates and pyrophosphates are preferably selected. Also, saponification products of the carboxylates, nitrates, sulfates, sulfonates, phosphates, phosphonates and pyrophosphates can more preferably be used.

As the carboxylates of any of the above-mentioned polysaccharides, one or more members selected from among alkylcarbonyl esters, alkenylcarbonyl esters, aromatic carbonyl esters and aralkylcarbonyl esters are preferably selected. Also, saponification products of the alkylcarbonyl esters, alkenylcarbonyl esters, aromatic carbonyl esters and aralkylcarbonyl esters of any of the above-mentioned polysaccharides can more preferably be used.

As the ester group of the alkylcarbonyl esters of any of the above-mentioned polysaccharides, one or more members selected from among an acetyl group, a propionyl group, a butyroyl group, a valeryl group, a heptanoyl group, an octanoyl group, a decanoyl group, a dodecanoyl group, a tridecanoyl group, a hexadecanoyl group and an octadecanoyl group are preferably selected. Also, saponification products of any of the above-mentioned polysaccharides having one or more ester groups selected from among an acetyl group, a propionyl group, a butyloyl group, a valeryl group, a heptanoyl group, an octanoyl group, a decanoyl group, a dodecanoyl group, a tridecanoyl group, a hexadecanoyl group and an octadecanoyl group can more preferably be used.

As the ester group of the alkenylcarbonyl esters of any of the above-mentioned polysaccharides, one or more of an acryl group and a methacryl group are preferably selected. Also, saponification products of any of the above-mentioned polysaccharides having ester groups of one or more of an acyl group and a methacryl group can more preferably be used.

As the ester group of the aromatic carbonyl esters of any of the above-mentioned polysaccharides, one or more of a benzoyl group and a naphthaloyl group are preferably selected. Also, saponification products of any of the above-mentioned polysaccharides having ester groups of one or more of a benzoyl group and a naphthaloyl group can more preferably be used.

As the nitrates of any of the polysaccharides, nitrocellulose, nitrohemicellulose, nitrodextran, nitroagarose, nitrodextrin, nitroamylase, nitroamylopectin, nitroglycogen, nitropullulan, nitromannan, nitroglucomannan, nitrolichenan, nitroisolichenan, nitrolaminaran, nitrocarrageenan, nitroxylan, nitrofructan, nitroalginic acid, nitrohyaluronic acid, nitrochondroitin, nitrochitin and nitrochitosan can preferably be used.

Also, saponification products of nitrocellulose, nitrohemicellulose, nitrodextran, nitroagarose, nitrodextrin, nitroamylase, nitroamylopectin, nitroglycogen, nitropullulan, nitromannan, nitroglucomannan, nitrolichenan, nitroisolichenan, nitrolaminaran, nitrocarrageenan, nitroxylan, nitrofructan, nitroalginic acid, nitrohyaluronic acid, nitrochondroitin, nitrochitin and nitrochitosan can more preferably be used.

As the sulfates of any of the polysaccharides, cellulose sulfate, hemicellulose sulfate, dextran sulfate, agarose sulfate, dextrin sulfate, amylase sulfate, amylopectin sulfate, glycogen sulfate, pullulan sulfate, mannan sulfate, glucomannan sulfate, lichenan sulfate, isolichenan sulfate, laminaran sulfate, carrageenan sulfate, xylan sulfate, fructan sulfate, alginic acid sulfate, hyaluronic acid sulfate, chondroitin sulfate, chitin sulfate and chitosan sulfate can preferably be used.

Also, saponification products of cellulose sulfate, hemicellulose sulfate, dextran sulfate, agarose sulfate, dextrin sulfate, amylase sulfate, amylopectin sulfate, glycogen sulfate, pullulan sulfate, mannan sulfate, glucomannan sulfate, lichenan sulfate, isolichenan sulfate, laminaran sulfate, carrageenan sulfate, xylan sulfate, fructan sulfate, alginic acid sulfate, hyaluronic acid sulfate, chondroitin sulfate, chitin sulfate and chitosan sulfate can more preferably be used.

As the sulfonates of any of the aforementioned polysaccharides, one or more members selected from among alkyl sulfonates, alkenyl sulfonates, aromatic sulfonates and aralkyl sulfonates are preferably selected. Also, saponification products of alkyl sulfonates, alkenyl sulfonates, aromatic sulfonates and aralkyl sulfonates of any of the above-mentioned polysaccharides can more preferably be used.

As the phosphates of any of the aforementioned polysaccharides, cellulose phosphate, hemicellulose phosphate, dextran phosphate, agarose phosphate, dextrin phosphate, amylase phosphate, amylopectin phosphate, glycogen phosphate, pullulan phosphate, mannan phosphate, glucomannan phosphate, lichenan phosphate, isolichenan phosphate, laminaran phosphate, carrageenan phosphate, xylan phosphate, fructan phosphate, alginic acid phosphate, hyaluronic acid phosphate, chondroitin phosphate, chitin phosphate and chitosan phosphate can preferably be used.

Also, saponification products of cellulose phosphate, hemicellulose phosphate, dextran phosphate, agarose phosphate, dextrin phosphate, amylase phosphate, amylopectin phosphate, glycogen phosphate, pullulan phosphate, mannan phosphate, glucomannan phosphate, lichenan phosphate, isolichenan phosphate, laminaran phosphate, carrageenan phosphate, xylan phosphate, fructan phosphate, alginic acid phosphate, hyaluronic acid phosphate, chondroitin phosphate, chitin phosphate and chitosan phosphate can more preferably be used.

As the phosphonates of any of the aforementioned polysaccharides, cellulose phosphonate, hemicellulose phosonphate, dextran phosphonate, agarose phosphonate, dextrin phosphonate, amylase phosphonate, amylopectin phosonphate, glycogen phosphonate, pullulan phosphonate, mannan phosphonate, glucomannan phosphonate, lichenan phosphonate, isolichenan phosphonate, laminaran phosphonate, carrageenan phosphonate, xylan phosphonate, fructan phosphonate, alginic acid phosphonate, hyaluronic acid phosphonate, chondroitin phosphonate, chitin phosphonate and chitosan phosphonate can preferably be used.

Also, saponification products of cellulose phosphonate, hemicellulose phosphonate, dextran phosphonate, agarose phosphonate, dextrin phosphonate, amylase phosphonate, amylopectin phosphonate, glycogen phosphonate, pullulan phosphonate, mannan phosphonate, glucomannan phosphonate, lichenan phosphonate, isolichenan phosphonate, laminaran phosphonate, carrageenan phosphonate, xylan phosphonate, fructan phosphonate, alginic acid phosphonate, hyaluronic acid phosphonate, chondroitin phosphonate, chitin phosphonate and chitosan phosphonate can more preferably be used.

As the pyrophosphates of any of the aforementioned polysaccharides, cellulose pyrophosphate, hemicellulose pyrophosphate, dextran pyrophosphate, agarose pyrophosphate, dextrin pyrophosphate, amylase pyrophosphate, amylopectin pyrophosphate, glycogen pyrophosphate, pullulan pyrophosphate, mannan pyrophosphate, glucomannan pyrophosphate, lichenan pyrophosphate, isolichenan pyrophosphate, laminaran pyrophosphate, carrageenan pyrophosphate, xylan pyrophosphate, fructan pyrophosphate, alginic acid pyrophosphate, hyaluronic acid pyrophosphate, chondroitin pyrophosphate, chitin pyrophosphate and chitosan pyrophosphate can preferably be used.

Also, saponification products of cellulose pyrpphosphate, hemicellulose pyrophosphate, dextran pyrophosphate, agarose pyrophosphate, dextrin pyrophosphate, amylase pyrophosphate, amylopectin pyrophosphate, glycogen pyrophosphate, pullulan pyrophosphate, mannan pyrophosphate, glucomannan pyrophosphate, lichenan pyrophosphate, isolichenan pyrophosphate, laminaran pyrophosphate, carrageenan pyrophosphate, xylan pyrophosphate, fructan pyrophosphate, alginic acid pyrophosphate, hyaluronic acid pyrophosphate, chondroitin pyrophosphate, chitin pyrophosphate and chitosan pyrophosphate can more preferably be used.

As the ether derivatives of any of the aforementioned polysaccharides, methyl cellulose, ethyl cellulose, carboxymethyl cellulose, carboxyethyl cellulose, carboxyethyl-carbamoylethyl cellulose, hydroxymethyl cellulose, hydroxyethyl cellulose, hydroxypropyl cellulose, hydroxypropylmethyl cellulose, hydroxyethylmethyl cellulose, cyanoethyl cellulose and carbamoyethyl cellulose can be used, though the ether derivatives not being limited thereto. It is preferable to use hydroxymethyl cellulose or hydroxyethyl cellulose.

Those wherein hydroxyl groups of any of the polysaccharides are halogenated with any substitution degree can also be preferably used.

As the porous membrane comprising an organic polymer having a polysaccharide structure, there is preferably illustrated acetylcellulose. It is also possible to use a porous membrane of an organic polymer comprising a mixture of acetylcelluloses different from each other in acetyl value. As a mixture of acetylcelluloses different from each other in acetyl value, there can preferably be used a mixture of triacetylcellulose and diacetylcellulose, a mixture of triacetylcellulose and monoacetylcellulose, a mixture of triacetylcellulose, diacetyl cellulose and monoacetylcellulose and a mixture of diacetylcellulose and monoacetylcellulose. In particular, a mixture of triacetylcellulose and diacetylcellulose can preferably be used. The mixing ratio of triacetylcellulose to diacetylcellulose (by weight) is preferably from 99:1 to 1:99, more preferably from 90:10 to 50:50.

As a particularly preferable porous membrane comprising acetylcellulose, there is illustrated a porous membrane comprising surface-saponified acetylcellulose, described in JP-A-2003-128691. The surface-saponified acetylcellulose is a product obtained by saponification treatment of a mixture of acetylcelluloses different in acetyl value, and a saponification product of a mixture of triacetylcellulose and diacetylcellulose, a saponification product of a mixture of triacetylcellulose and monoacetylcellulose, a saponification product of a mixture of triacetylcellulose, diacetylcelluloce and monoacetylcellulose, and a saponification product of a mixture of diacetylcellulose and monoacetylcellulose can also be preferably used. It is more preferable to use a saponification product of a mixture of triacetylcellulose and diacetylcellulose. The mixing ratio of triacetylcellulose to diacetylcellulose (by weight) is preferably from 99:1 to.1:99, more preferably from 90:10 to 50:50. In this case, the amount (density) of hydroxyl group on the solid phase surface can be controlled by adjusting the degree of saponification treatment (saponification ratio). In order to enhance the efficiency of separating nucleic acids, a larger amount (density) of hydroxyl group is preferred. The saponification ratio (surface saponification ratio) of the porous membrane obtained by the saponification treatment is preferably from 5% to 100%, more preferably from 10% to 100%.

The porous membrane is preferably a porous membrane which undergoes reduction in average pore size after the saponification treatment in comparison with that before the saponification treatment. A porous membrane of 0.8 or less in the ratio of average pore size after the saponification treatment to average pore size before the saponification treatment is preferred, with a porous membrane of 0.5. or less in the ratio being more preferred.

The saponification treatment means to allow acetylcellulose to come into contact with a saponification-treating solution (e.g., an aqueous solution of sodium hydroxide). Part of acetylcellulose allowed to contact with the saponification-treating solution is converted to regenerated cellulose, thus hydroxyl group being introduced. The thus-prepared regenerated cellulose is different from original cellulose in the point of crystal state, etc. In the invention, it is preferable to use a porous membrane of regenerated cellulose as the porous membrane.

Also, in order to change the saponification ratio, it suffices to conduct the saponification treatment with changing the concentration of sodium hydroxide. The saponification ratio can easily be measured by NMR, IR or XPS (for example, being determined through the degree of reduction in the peak for carbonyl group).

As a method for introducing a hydrophilic group into a porous membrane not having the hydrophilic group, it is possible to connect a graft polymer having a hydrophilic group within the polymer chain or in the side chain to the porous membrane.

As a method for connecting a graft polymer chain to the porous membrane of an organic material, there are two methods: one being a method of chemically connecting the porous membrane to the graft polymer chain; and the other being a method of polymerizing a compound having a polymerizable double bond starting from the porous membrane to form a graft polymer chain.

First, in the method of chemically connecting the porous membrane to the polymer chain, a poloymer having at the end or in the side chain a functional group capable of reacting with the porous membrane, and this functional group is chemically reacted with the functional group of the porous membrane, thus graft being formed. The functional group capable of reacting with the porous membrane is not particularly limited so long as it can react with the functional group of the porous membrane, and examples thereof include a silane coupling group such as alkoxysilane, an isocyanato group, an amino group, a hydroxyl group, a carboxyl group, a sulfonic acid group, a phosphoric acid group, an epoxy group, an allyl group, a methacryloyl group and an acryloyl group.

Examples of particularly useful compounds having a reactive functional group at the end or in the side chain of the polymer include a polymer having a trialkoxysilyl group at the end thereof, a polymer having an amino group at the end thereof, a polymer having a carboxyl group at the end thereof, a polymer having an epoxy group at the end thereof, and a polymer having an isocyanato group at the end thereof. The polymer to be used here is not particularly limited so long as it has a hydrophilic group participating in adsorption of nucleic acid, and specific examples thereof include polyhydroxyethyl acrylate, polyhydroxyethyl methacrylate and the salts thereof, polyvinyl alcohol, polyvinyl pyrrolidone, polyacryolic acid, polymethacrylic acid and the salts thereof, and polyoxyethylene.

The method for forming a graft polymer chain by polymerizing a compound having a polymerizable double bond with starting from a porous membrane is generally called surface graft polymerization. The surface graft polymerization method is a method wherein an active species is formed on the surface of a substrate by irradiation with plasma or light, or by heating, and a compound having a polymerizable double bond disposed in contact with the porous membrane is polymerized from the species, thus being connected to the porous membrane.

Compounds useful for forming a graft polymer chain connected to the substrate are required to have a polymerizable double bond and a hydrophilic group participating in adsorption of nucleic acid. As such compounds, any of hydrophilic group-having polymers, hydrophilic group-having oligomers and hydrophilic group-having monomers can be used as long as they have a double bond within the molecule. Particularly useful compounds are monomers having a hydrophilic group.

As particularly useful specific examples of monomers having a hydrophilic group, the following monomers can be used. For example, monomers having a hydroxyl group such as 2-hydroxyethyl acrylate, 2-hydroxyethyl methacrylate and glycerol monomethacrylate can be particularly preferably used. Also, carboxyl group-having monomers such as acrylic acid and methacrylic acid, or the alkali metal salts and amine salts thereof, can preferably be used.

As another method for introducing a hydrophilic group into a porous membrane comprising an organic material having no hydrophilic group, a material having a hydrophilic group can be coated. The material to be used for the coating is not particularly limited as long as it has a hydrophilic group participating in adsorption of nucleic acid. In view of handling ease, polymers of an organic material are preferred. Examples of the polymer include polyhydroxyethyl acrylate, polyhydroxyethyl methacrylate and the salts thereof, polyvinyl alcohol, polyvinyl pyrrolidone, polyacrylic acid, polymethacrylic acid and the salts thereof, polyoxyethylene, acetylcellulose and a mixture of acetylcelluloses different from each other in acryl value, with polymers having a polysaccharide structure being preferred.

Also, after coating acetylcellulose or a mixture of acetylcelluloses different from each other in acetyl value on a porous membrane of an organic material having no hydrophilic group, the coated acetylcellulose or mixture of acetylcelluloses different in acetyl value can be subjected to saponification treatment. In this case, the saponification ratio is preferably about 5% or more, more preferably about 10% or more.

As a porous membrane comprising an inorganic material having a hydrophilic group, there can be illustrated a porous membrane containing a silica compound. Examples of a porous membrane containing a silica compound include a glass filter and a porous thin film of silica as described in Japanese Patent No. 3,058,342. This porous thin film of silica can be formed by spreading on a substrate a solution of a cationic amphiphatic substance having a bimolecular film-forming ability, removing a solvent from the liquid film on the substrate to form a multi-layer bimolecular thin film of the amphiphatic substance, allowing the multi-layer bimolecular thin film to come into contact with a solution containing a silica compound, then extracting away the multi-layer bimolecular thin film.

As a method for introducing a hydrophilic group into an inorganic material having no hydrophilic group, there are two methods: one being a method of chemically connecting the porous membrane to the graft polymer chain; and the other being a method of using a monomer having a polymerizable double bond within the molecule with starting from the porous membrane to form a graft polymer chain.

In the method of chemically connecting the porous membrane to the polymer chain, a functional group capable of reacting with the terminal functional group of a graft polymer is introduced into the inorganic material, and the graft polymer is chemically connected to the functional group introduced into the inorganic material. Also, in the case of using a monomer having a double bond within the molecule and having a hydrophilic group, and polymerizing the monomer with starting from the porous membrane to thereby form a graft polymer chain, a functional group functioning as a starting point upon polymerization of the compound having a double bond is introduced into the inorganic material. As the graft polymer having a hydrophilic group and the monomer having a double bond within the molecule and having a hydrophilic group, those graft polymers having a hydrophilic group and those monomers having a double bond within the molecule and having a hydrophilic group which are illustrated with respect to the method for chemically bonding the porous membrane to the graft polymer chain can preferably be used.

As another method for introducing a hydrophilic group into a porous membrane comprising an inorganic material having no hydrophilic group, a material having a hydrophilic group can be coated. The material to be used for the coating is not particularly limited as long as it has a hydrophilic group participating in adsorption of nucleic acid. In view of handling ease, polymers of an organic material are preferred. Examples of the polymer include polyhydroxyethyl acrylate, polyhydroxyethyl methacrylate and the salts thereof, polyvinyl alcohol, polyvinyl pyrrolidone, polyacrylic acid, polymethacrylic acid and the salts thereof, polyoxyethylene, acetylcellulose and a mixture of acetylcelluloses different from each other in acryl value.

Also, after coating acetylcellulose or a mixture of acetylcelluloses different from each other in acetyl value on a porous membrane of an inorganic material having no hydrophilic group, the coated acetylcellulose or mixture of acetylcelluloses different in acetyl value can be subjected to saponification treatment. In this case, the saponification ratio is preferably about 5% or more, more preferably about 10% or more.

Examples of the porous membrane comprising an inorganic material having no hydrophilic group include porous membranes prepared by processing a metal such as aluminum, glass, cement, ceramics such as pottery, new ceramics, silicon or active carbon.

As the above-mentioned nucleic acid-adsorbing porous membrane through which a solution can pass, a porous membrane having a thickness of 10 μm to 500 μm can be used. More preferably, a porous membrane having a thickness of 50 μm to 250 μm can be used. In view of washing convenience, it is better for the porous membrane to have a smaller thickness.

Also, as the above-mentioned nucleic acid-adsorbing porous membrane through which a solution can pass, it is preferable to use a porous membrane having an average pore size of 0.9 to 5.0 μm. More preferably, a porous membrane having an average pore size of 1.5 to 3.5 μm is used. Such pore size serves to provide enough surface area for nucleic acids to adsorb and reduce clogging, thus being preferred. The average pore size of a porous membrane through which a solution can pass can be determined according to the bubble point method (based on ASTMF316-86, JISK3832).

The solid phase through which a solution can pass may be a porous membrane having a front surface and a back surface symmetrical with each other, but is preferably a porous membrane having a front surface and a back surface asymmetrical with each other. The term “having a front surface and a back surface asymmetrical with each other” as used herein means that physical and/or chemical properties of the membrane change from one surface of the porous membrane to the other surface thereof. An example of the physical properties is an average pore size. Also, an example of the chemical properties is a saponification degree. In the case of using a porous membrane having a front surface and a back surface asymmetrical with each other in terms of average pore size, it is preferable to adjust so that the average pore size changes from a larger size to a smaller size in a direction along which a solution passed through the membrane. It is preferable to use a porous membrane having a maximum pore size/minimum pore size ratio of 2 or more. The maximum pore size/minimum pore size ratio is more preferably 5 or more. Thus, an enough surface area for nucleic acids to adsorb can be obtained, and clogging difficultly takes place.

Also, as the above-mentioned nucleic acid-adsorbing porous membrane through which a solution can pass, a porous membrane having a void volume of 50 to 95% can be used. More preferably, a porous membrane having a void volume of 65 to 80% can be used. Also, as the above-mentioned nucleic acid-adsorbing porous membrane through which a solution can pass, a porous membrane having a bubble point of 0.1 to 10 kgf/cm² can be used. More preferably, a porous membrane having a bubble point of 0.2 to 4 kgf/cm² can be used.

Also, as the above-mentioned nucleic acid-adsorbing porous membrane through which a solution can pass, it is preferable to use a porous membrane showing a pressure loss of 0.1 to 100 kPa. Such membrane serves to obtain a uniform pressure upon applying pressure, thus being preferred. More preferably, a porous membrane showing a pressure loss of 0.5 to 50 kPa can be used. The term “pressure loss” as used herein means a minimum pressure necessary for passing water per 100 μm in thickness of the membrane.

Also, as the above-mentioned nucleic acid-adsorbing porous membrane through which a solution can pass, a porous membrane which passes water in an amount of 1 to 5000 mL per cm per minute when a pressure of 1 kg/cm² is applied at 25° C. can be used. More preferably, a porous membrane which passes water in an amount of 5 to 1000 mL per cm² per minute when a pressure of 1 kg/cm² is applied at 25° C. can be used.

Also, as the above-mentioned nucleic acid-adsorbing porous membrane through which a solution can pass, a porous membrane which adsorbs nucleic acids in an amount of 0.1 μg more more per mg thereof can preferably be used. More preferably, a porous membrane which adsorbs nucleic acids in an amount of 0.9 μg more more per mg thereof can be used.

Also, as the above-mentioned nucleic acid-adsorbing porous membrane through which a solution can pass, a porous membrane which, when a 5×5-mm square sample thereof is dipped in 5 mL of trifluoroacetic acid, does not dissolve within 1 hour but dissolve within 48 hours can preferably be used. Also, a porous membrane comprising a cellulose derivative which membrane, when a 5×5-mm square sample thereof is dipped in 5 mL of trifluoroacetic acid, dissolves within 1 hour but, when dipped in 5 mL of dichloromethane, does not dissolve within 48 hours can preferably be used.

In the case of passing a sample solution containing nucleic acids through the nucleic acid-adsorbing porous membrane, it is preferable to pass the sample solution from one surface to the other surface in the point of allowing the solution to come into uniform contact with the porous membrane. In the case of passing a sample solution containing nucleic acids through the nucleic acid-adsorbing porous membrane, it is preferable to pass the sample solution from the side having a larger pore size to the side having a smaller pore size in the point of reducing clogging.

In the case of passing a sample solution containing nucleic acids through the nucleic acid-adsorbing porous membrane, the flow rate is preferably 2 to 1500 μL/sec per cm² of the area of membrane in order to obtain an appropriate contact time of the solution with the porous membrane. In case when the contact time of the solution with the porous membrane is too short, sufficient separating and purifying effect cannot be obtained, whereas a too long contact time is not favorable in view of operating aspect. Further, the flow rate is more preferably 5 to 700 μL/sec per cm² of the area of membrane.

Also, the number of the nucleic acid-adsorbing porous membrane through which a solution to be used can pass may be one, but a plurality of membranes may be used as well. A plurality of nucleic acid-adsorbing membranes may be the same as, or different from, each other.

A cartridge for separation and purification of nucleic acid can be used wherein the nucleic acid-adsorbing porous membrane through which the solution as described above can pass is contained in a container having at least two openings. Also, a cartridge for separation and purification of nucleic acid can preferably be used wherein a plurality of the nucleic acid-adsorbing porous membranes through which the solution as described above can pass are contained in a container having at least two openings. In this case, a plurality of the nucleic acid-adsorbing porous membranes contained in a container having at least two openings may be the same as, or different from, each other.

A plurality of nucleic acid-adsorbing porous membranes may be a combination of a nucleic acid-adsorbing porous membrane comprising an inorganic material and a nucleic acid-adsorbing porous membrane comprising an organic material. For example, there is illustrated a combination of a glass filter and a porous membrane of regenerated cellulose. Also, a plurality of nucleic acid-adsorbing porous membrane may be a nucleic acid-adsorbing porous membrane comprising an inorganic material and a nucleic acid-adsorbing porous membrane comprising an organic material. For example, there is illustrated a combination of a glass filter and a porous membrane of nylon or polysulfon.

The cartridge for separation and purification of nucleic acid preferably does not contain other members than the nucleic acid-adsorbing porous membrane through which a solution as described above can pass, within the container having at least two openings. As materials for the container, plastics such as polypropylene, polystyrene, polycarbonate and polyvinyl chloride can be used. Also, biodegradable materials can be used. The container may be transparent or colored.

As the cartridge for separation and purification of nucleic acid, a cartridge for separation and purification of nucleic acid equipped with a means for discriminating individual cartridges can be used. Examples of the means for discriminating individual cartridges for separation and purification include bar code and magnetic tape.

Also, a cartridge for separation and purification of nucleic acid having a structure which permits to easily take the nucleic acid-adsorbing porous membrane out of the container having at least two openings can be used.

Nucleic acids can be separated and purified by the following steps using the above-described cartridge for separation and purification of nucleic acid containing a nucleic acid-adsorbing porous membrane through which each solution can pass.

That is, there are included the steps of:
(a) injecting a sample solution containing nucleic acids in one opening of a cartridge for separation and purification of nucleic acid comprising a container having at least two openings and containing a nucleic acid-adsorbing porous membrane through which the solution can pass;
(b) creating an increased pressure condition in the cartridge for separation and purification of nucleic acid using a pressure difference-generating apparatus connected to the above-mentioned one opening of the cartridge for separation and purification of nucleic acid to thereby pass the injected sample solution containing nucleic acids through the nucleic acid-adsorbing porous membrane and discharge it out of the other opening of the cartridge for separation and purification of nucleic acid, thus nucleic acids being adsorbed to the nucleic acid-adsorbing porous membrane;
(c) injecting a washing solution in the above-described one opening of the cartridge for separation and purification of nucleic acid;
(d) creating an increased pressure condition in the cartridge for separation and purification of nucleic acid using a pressure difference-generating apparatus connected to the above-mentioned one opening of the cartridge for separation and purification of nucleic acid to thereby pass the injected washing solution through the nucleic acid-adsorbing porous membrane and discharge it out of the other opening of the cartridge for separation and purification of nucleic acid, thus the nucleic acid-adsorbing porous membrane being washed with nucleic acid remaining adsorbed;
(e) injecting a recovering solution in the above-described one opening of the cartridge for separation and purification of nucleic acid; and
(f) creating an increased pressure condition in the cartridge for separation and purification of nucleic acid using a pressure difference-generating apparatus connected to the above-mentioned one opening of the cartridge for separation and purification of nucleic acid to thereby pass the injected recovering solution through the nucleic acid-adsorbing porous membrane and discharge it out of the other opening of the cartridge for separation and purification of nucleic acid, thus nucleic acids being desorbed from the nucleic acid-adsorbing porous membrane and discharged out of the container of the cartridge for separation and purification of nucleic acid.

In another embodiment, there can be conducted the steps of:
(a) injecting a sample solution containing nucleic acids in one opening of a cartridge for separation and purification of nucleic acid comprising a container having at least two openings and containing a nucleic acid-adsorbing porous membrane through which the solution can pass;
(b) creating a reduced pressure condition in the cartridge for separation and purification of nucleic acid using a pressure difference-generating apparatus connected to the other opening of the cartridge for separation and purification of nucleic acid to thereby pass the injected sample solution containing nucleic acids through the nucleic acid-adsorbing porous membrane and discharge it out of the other opening of the cartridge for separation and purification of nucleic acid, thus nucleic acids being adsorbed to the nucleic acid-adsorbing porous membrane;
(c) injecting a washing solution in the above-described one opening of the cartridge for separation and purification of nucleic acid;
(d) creating a reduced pressure condition in the cartridge for separation and purification of nucleic acid using a pressure difference-generating apparatus connected to the other opening of the cartridge for separation and purification of nucleic acid to thereby pass the injected washing solution through the nucleic acid-adsorbing porous membrane and discharge it out of the other opening of the cartridge for separation and purification of nucleic acid, thus the nucleic acid-adsorbing porous membrane being washed with nucleic acid remaining adsorbed;
(e) injecting a recovering solution in the above-described one opening of the cartridge for separation and purification of nucleic acid; and
(f) creating a reduced pressure condition in the cartridge for separation and purification of nucleic acid using a pressure difference-generating apparatus connected to the other opening of the cartridge for separation and purification of nucleic acid, or acting centrifugal force to the cartridge for separation and purification of nucleic acid, to thereby pass the injected recovering solution through the nucleic acid-adsorbing porous membrane and discharge it out of the other opening of the cartridge for separation and purification of nucleic acid, thus nucleic acids being desorbed from the nucleic acid-adsorbing porous membrane and discharged out of the container of the cartridge for separation and purification of nucleic acid.

In yet another embodiment, there can be conducted the steps of:
(a) injecting a sample solution containing nucleic acids in one opening of a cartridge for separation and purification of nucleic acid comprising a container having at least two openings and containing a nucleic acid-adsorbing porous membrane through which the solution can pass;
(b) acting a centrifugal force to the cartridge for separation and purification of nucleic acid to thereby pass the injected sample solution containing nucleic acids through the nucleic acid-adsorbing porous membrane and discharge it out of the other opening of the cartridge for separation and purification of nucleic acid, thus nucleic acids being adsorbed to the nucleic acid-adsorbing porous membrane;
(c) injecting a washing solution in the above-described one opening of the cartridge for separation and purification of nucleic acid;
(d) acting a centrifugal force to the cartridge for separation and purification of nucleic acid to thereby pass the injected washing solution through the nucleic acid-adsorbing porous membrane and discharge it out of the other opening of the cartridge for separation and purification of nucleic acid, thus the nucleic acid-adsorbing porous membrane being washed with nucleic acid remaining adsorbed;
(e) injecting a recovering solution in the above-described one opening of the cartridge for separation and purification of nucleic acid; and
(f) acting a centrifugal force to the cartridge for separation and purification of nucleic acid to thereby pass the injected recovering solution through the nucleic acid-adsorbing porous membrane and discharge it out of the other opening of the cartridge for separation and purification of nucleic acid, thus nucleic acids being desorbed from the nucleic acid-adsorbing porous membrane and discharged out of the container of the cartridge for separation and purification of nucleic acid.

The washing step is described below. The washing operation serves to improve the amount and purity of recovered nucleic acid and reduce the necessary amount of a sample containing nucleic acids. Also, by automating the washing and recovering operations, the operations can be made convenient and accelerated. The washing step may be conducted only once for expeditious operation and, in the case where purity is of more importance, the washing operation is preferably repeated several times.

In the washing step, the washing solution is fed to a cartridge for separation and purification of nucleic acid containing a nucleic acid-adsorbing porous membrane by using a tube, a pipette or an automatically injecting device, or a means having the same function as these. The thus-fed washing solution is fed through one opening of the cartridge for separation and purification of nucleic acid (the opening through which the sample solution containing nucleic acids having been injected), and an increased pressure condition is created in the cartridge for separation and purification of nucleic acid by using a pressure difference-generating apparatus (e.g., a dropping pipette, a syringe, a pump or a powered pipette) to thereby pass the washing solution through the nucleic acid-adsorbing porous membrane and discharge through the other opening different from the above-described opening. Also, it is possible to feed the washing solution through one opening and discharge through the same opening. Further, it is possible to feed the washing solution through an opening of the cartridge for separation and purification of nucleic acid different from the opening through which the sample solution containing nucleic acids has been fed. However, a method of feeding the washing solution through one opening of the cartridge for separation and purification of nucleic acid, allowing the washing solution to pass through the nucleic acid-adsorbing porous membrane, and discharging through an opening different from the opening through which it has been fed is excellent in washing efficiency, thus being preferred.

The amount of washing solution in the washing step is preferably 2 μl/mm² or more. In case when the amount of the washing solution is large, washing efficiency is increased. In order to maintain good operability and prevent washing loss of the sample, the amount is preferably 200 μl/mm² or less.

In the washing step, the flow rate of the washing solution upon passing through the nucleic acid-adsorbing porous membrane is preferably 2 to 1500 μL/sec per cartridge area (cm²) of the membrane, more preferably 5 to 700 μL/sec. When the passing rate is reduced to prolong washing, washing efficiency is increased that much. However, acceleration of the operation for separation and purification of nucleic acid is also of importance, and hence the above-described range is selected.

In the washing step, the temperature of the washing solution is preferably 4 to 70° C. More preferably, the temperature of the washing solution is room temperature.

Also, in the washing step, washing can also be conducted while stirring by mechanically vibrating the cartridge for separation and purification of nucleic acid or by applying ultrasonic wave thereto, or can be conducted by centrifugation.

In the washing step, enzymes such as nuclease are not generally incorporated in the washing solution, but enzymes capable of decomposing impurities such as protein can be incorporated. Also, in some cases, DNA-decomposing enzyme or RNA-decomposing enzyme can be incorporated. By using a washing solution containing DNA-decomposing enzyme, only RNA in the sample can be selectively recovered. Conversely, by using a washing solution containing RNA-decomposing enzyme, only DNA in the sample can be selectively recovered.

In the washing step, the washing solution is preferably a solution containing a water-soluble organic solvent and/or a water-soluble salt. The washing solution is required to exert the function of washing out impurities contained in the sample solution adsorbed to the nucleic acid-adsorbing porous membrane along with nucleic acids. Therefore, it must have such a composition that it desorbs only impurities from the nucleic acid-adsorbing porous membrane, and not the nucleic acids. For this purpose, a water-soluble organic solvent such as an alcohol is appropriate for desorbing other ingredients than nucleic acids with leaving nucleic acids on the porous membrane, since nucleic acids are slightly soluble in such solvent. Also, addition of a water-soluble salt enhances the adsorbing effect of nucleic acids, thus selective removal of unnecessarily ingredients being improved.

As the water-soluble organic solvent to be incorporated in the washing solution, methanol, ethanol, isopropanol, n-isopropanol, butanol and acetone can be used. Among these, ethanol is preferably used. The amount of the water-soluble organic solvent incorporated in the washing solution is preferably 20 to 100% by weight, more preferably 40 to 80%.

On the other hand, the water-soluble salt to be incorporated in the washing solution is preferably a salt of halide, with chloride being preferred. Also, the water-soluble salt is preferably a salt of monovalent or divalent cation, particularly preferably an alkali metal salt or an alkaline earth metal salt. Of them, a sodium salt and a potassium salt are preferred, with a sodium salt being most preferred.

In the case of incorporating the water-soluble salt in the washing solution, the concentration is preferably 10 mM/L or more. The upper limit of the concentration is not particularly limited and may be within a range of not spoiling solubility of impurities. However, the concentration is preferably 1 M/L or less, more preferably 0.1 M/L or less.

The water-soluble salt is particularly preferably sodium chloride, and its concentration is particularly preferably 20 mM/L or more.

The washing solution preferably does not contain any chaotropic substance, which serves to reduce the possibility of entrainment of the chaotropic substance into the recovering step subsequent to the washing step. In case when the chaotropic substance is entrained into the recovering step, it would often inhibit enzyme reactions such as PCR. Thus, in consideration of the subsequent enzyme reaction, it is ideal that the chaotropic substance is not contained in the washing solution. Also, since the chaotropic substance is corrosive and harmful, unnecessity of the chaotropic substance is extremely advantageous for experimentalists in view of safety in testing operation.

The chaotropic substances are urea, guanidine salts, sodium isocyanate, sodium iodide, potassium iodide, etc. as has been described hereinbefore.

Heretofore, in the washing step in the process of separating and purifying nucleic acids, the washing solution have often remained in the container such as the cartridge due to wetting properties of the solution to the container. This has been the cause of reduction in purity of resultant nucleic acid or in reactivity in the subsequent step due to entrainment of the washing solution into the recovering step subsequent to the washing step. Therefore, in the case of conducting adsorption and desorption of nucleic acids using a container such as a cartridge, it is of importance that solutions used for adsorption or washing, particularly the washing solution, should not remain within the cartridge for avoiding detrimental influences in the subsequent step.

Accordingly, in order to prevent the washing solution used in the washing step from entraining into the subsequent recovering solution and minimize the residual amount of the washing solution within the cartridge, the washing solution has a surface tension of preferably 0.035 J/m² or less. Wetting properties between the washing solution and the cartridge is improved by reducing the surface tension of the washing solution, thus the amount of the residual solution being depressed.

Conversely, for the purpose of reducing the residual amount of the washing solution in the cartridge, the surface tension of the washing solution can be adjusted to 0.035 J/m² or more to thereby enhance water-repelling properties for forming droplets which flow downward. A proper surface tension is selected depending upon the combination of the porous membrane having adsorbed thereto nucleic acids, the recovering solution and the washing solution.

The washing step can be simplified by utilizing the nucleic acid-adsorbing porous membrane of the invention. That is, (1) the number of times of passing the washing solution through the nucleic acid-adsorbing porous membrane may be once, (2) the washing step can be conducted at room temperature, (3) the recovering solution can be injected into the cartridge immediately after washing, and (4) one or more of these (1), (2) and (3) are possible. In the conventional methods, a drying step is often required in order to rapidly remove the organic solvent contained in the washing solution. However, the nucleic acid-adsorbing porous membrane in accordance with the invention can eliminate the necessity of the drying step due to its small thickness.

In the process of separating and purifying nucleic acids, the washing step has involved the problem that the washing solution often scatters and deposits on other portions, thus causing contamination of a sample. This type of contamination having been experienced in the washing step can be prevented by properly designing the shape of the cartridge for separation and purification of nucleic acid comprising a container having two openings and containing a nucleic acid-adsorbing membrane and the shape of a waste liquor container.

The step of desorbing nucleic acids from the nucleic acid-adsorbing membrane to recover them is described below.

In the recovering step, the recovering solution is fed to a cartridge for separation and purification of nucleic acid equipped with a nucleic acid-adsorbing porous membrane by using a tube, a pipette or an automatic injecting device, or a means exerting the same function as these. The recovering solution is fed through one opening of the cartridge for separation and purification of nucleic acid (the opening through which the sample solution containing nucleic acids having been injected), and an increased pressure condition is created in the cartridge for separation and purification of nucleic acid by using a pressure difference-generating apparatus (e.g., a dropping pipette, a syringe, a pump or a powered pipette) to thereby pass the washing solution through the nucleic acid-adsorbing porous membrane and discharge through the other opening different from the above-described opening. Also, it is possible to feed the recovering solution through one opening and discharge through the same opening. Further, it is possible to feed the recovering solution through an opening of the cartridge for separation and purification of nucleic acid different from the opening through which the sample solution containing nucleic acids has been fed. However, a method of feeding the recovering solution through one opening of the cartridge for separation and purification of nucleic acid, allowing the washing solution to pass through the nucleic acid-adsorbing porous membrane, and discharging through an opening different from the opening through which it has been fed is excellent in recovering efficiency, thus being preferred.

Desorption of nucleic acids can be conducted by adjusting the volume of the recovering solution based on the volume of the sample solution which contains nucleic acids and which has been prepared from a sample. The amount of the recovering solution containing separated and purified nucleic acid varies depending upon the amount of a used sample. A generally often employed amount of the recovering solution is several-ten to several-hundred μl. However, when the amount of a sample is extremely slight or, conversely, when a large amount of nucleic acids are required to be separated and purified, the amount of the recovering solution can be varied in the range of from 1 μl to several-ten ml.

As the recovering solution, a purified distilled water or a buffer aqueous solution such as a Tris/EDTA buffer can be used. Also, in the case of subjecting a recovered nucleic acid to PCR (Polymerase Chain Reaction), a buffer solution to be used in the PCR reaction (e.g., an aqueous solution having final concentrations of 50 mmol/l of KCl, 10 mmol/l of Tris-Cl, and 1.5 mmol/l of MgCl₂) can be used.

The pH of the recovering solution is preferably 2 to 11, more preferably 5 to 9. Ionic strength and concentration of salt of the recovering solution influence elution of the adsorbed nucleic acids. The recovering solution has an ionic strength of preferably 290 mmol/L or less and a salt concentration of preferably 90 mmol/L or less. Such recovering solution serves to improve the recovering ratio of nucleic acids, thus more amounts of nucleic acids being recovered. The nucleic acids to be recovered may be any of DNA, RNA, single-stranded nucleic acid, double-stranded nucleic acid, straight-chained nucleic acid and cyclic nucleic acid.

A recovering solution containing nucleic acid in a concentrated condition can be obtained by using a less volume of the recovering solution in comparison with the volume of the initial sample solution containing nucleic acids. The ratio of (volume of the recovering solution): volume of the sample solution) can preferably be 1:100 to 99:100, more preferably be 1:10 to 9:10, whereby nucleic acids can be concentrated with ease without conducting any concentrating operation in the step after separation and purification of nucleic acid. Thus, there can be provided a method which provides a nucleic acid solution wherein the nucleic acid is more concentrated than in the sample.

As another method, a recovering solution containing nucleic acid in a desired concentration can be obtained by conducting the desorption of nucleic acids under the condition where the volume of the recovering solution is larger than the volume of the initial sample solution containing nucleic acids. Thus, a recovering solution containing nucleic acid in a concentration suited for the subsequent step (e.g., PCR) can be obtained. The ratio of (volume of the recovering solution): volume of the sample solution) can preferably be 1:1 to 50:1, more preferably be 1:1 to 5:1, whereby there is provided a merit that troublesome adjustment of the concentration after separation and purification of nucleic acid can be eliminated. Further, use of a sufficient volume of the recovering solution serves to increase the recovering ratio of nucleic acid from the porous membrane.

Also, by changing the temperature of the recovering solution, nucleic acids can be recovered easily. For example, by conducting desorption of nucleic acids from the porous membrane using the recovering solution having a temperature of 0 to 10° C., function of nuclease can be depressed without any reagent or any special operation for preventing decomposition by nuclease, whereby decomposition of nucleic acids is prevented and a nucleic acid solution can be obtained with ease and good efficiency.

Also, when the temperature of the recovering solution is adjusted to 10 to 35° C., recovery of nucleic acid can be conducted at room temperature, thus nucleic acids being desorbed, separated and purified without complicated steps.

In yet another method, desorption of nucleic acids from the porous membrane can be conducted with ease in a high recovering ratio without any complicated operation by adjusting the temperature of the recovering solution to an elevated temperature of, for example, 35 to 70° C.

The number of times of injecting the recovering solution is not limited, and may be once or more times. Usually, in the case of separating and purifying nucleic acids conveniently and expeditiously, the injection is conducted once. However, in the case of, for example, recovering a large amount of nucleic acids, injection of the recovering solution is in some cases conducted several times.

In the recovering step, composition of the recovering solution for recovering nucleic acids can be adjusted so that it can be used as such in the subsequent post steps. The thus separated and purified nucleic acid is often amplified by PCR (Polymerase Chain Reaction) method. In this case, the separated and purified solution containing nucleic acid must be diluted with a buffer solution adapted for the PCR method. In the recovering step of the present method, use of a buffer solution adapted for the PCR method as the recovering solution permits the solution to be conveniently and expeditiously subjected to the subsequent PCR step.

Also, in the recovering step, it is possible to add a stabilizer to the nucleic acid-recovering solution. Examples of the stabilizer to be added include antimicrobial agents, antifungal agents and inhibitors for decomposition of nucleic acid. As a nuclease inhibitor, there is illustrated EDTA. As another embodiment; the stabilizer can be previously added to the recovering container.

The recovering container to be used in the recovering step is not particularly limited, and a recovering container made of a material not absorbing light of 260 nm can be used. Such container enables one to measure the concentration of the nucleic acid solution without transferring the solution to other container. Examples of the material not absorbing light of 260 nm include quartz glass, etc., but the material is not limited to them.

The step of separating and purifying nucleic acid from a sample containing nucleic acids by using a cartridge for separation and purification of nucleic acid comprising a container having two openings and containing a nucleic acid-adsorbing porous membrane therein and a pressure difference-generating apparatus is preferably conducted by using an automatic apparatus wherein the steps are automatically conducted. Such apparatus makes the operation convenient and expeditious and can provide nucleic acids having a definite level quality regardless of the ability of workers.

An embodiment of an automatic apparatus wherein the steps of separating and purifying nucleic acids from a nucleic acid-containing sample are automatically conducted using a cartridge for separation and purification of nucleic acid comprising a container having at least two openings and containing therein a nucleic acid-adsorbing membrane and using a pressure generator. However, the automatic apparatus is not limited only to this.

The automatic apparatus is an apparatus for automatically separating and purifying nucleic acid wherein a nucleic acid-containing sample solution is injected into a cartridge for separation and purification of nucleic acid containing a nucleic acid-adsorbing membrane, an increased pressure condition is created to adsorb nucleic acids in the sample solution to the nucleic acid-adsorbing porous membrane, a washing solution is injected into the cartridge for separation and purification of nucleic acid, an increased pressure condition is created to remove impurities, a recovering solution is injected into the cartridge for separation and purification of nucleic acid to desorb the nucleic acids adsorbed to the nucleic acid-adsorbing porous membrane and recover them along with the recovering solution. The automatic apparatus comprises a mechanism for holding the cartridge for separation and purification of nucleic acid, a waste liquor container for the discharged sample solution and the discharged washing solution and a recovering container for containing the recovering solution containing nucleic acid, a pressure air-feeding mechanism for introducing a pressure air into the cartridge for separation and purification of nucleic acid, and a mechanism for separately injecting the washing solution and the recovering solution into the cartridge for separation and purification of nucleic acid.

The holding mechanism is preferably a mechanism which has a stand mounted on the main body of the apparatus, a cartridge holder vertically movably supported on the stand and holding the cartridge for separation and purification of nucleic acid, and a holder for holding the waste liquor container and the recovering container at a position below the cartridge holder so that the relative position with respect to the cartridge can be changed.

Also, the pressure air-feeding mechanism is preferably a mechanism which has an air nozzle for jetting pressure air from the lower end portion, a pressure head for supporting and vertically moving the air nozzle with respect to the cartridge for separation and purification of nucleic acid held in the cartridge holder, and a positioning means provided on the pressure head and functioning to position the cartridge for separation and purification of nucleic acid in the rack of the holding mechanism.

Also, the separately injecting mechanism is preferably a mechanism which has a washing solution-injecting nozzle for injecting the washing solution, a recovering solution-injecting nozzle for injecting the recovering solution, a nozzle-shifting rack holding the washing solution-injecting nozzle and the recovering solution-injecting nozzle and capable of migrating in sequence over the cartridges for separation and purification of nucleic acid held by the holding mechanism, a washing solution-feeding pump for sucking the washing solution from a bottle containing the washing solution and feeding the washing solution to the washing solution-injecting nozzle, and a recovering solution-feeding pump for sucking the recovering solution from a bottle containing the recovering solution and feeding the recovering solution to the recovering solution-feeding nozzle.

According to the automatic apparatus as described above, a mechanism can be compactly constituted which is equipped with a holding mechanism for holding a cartridge for separation and purification of nucleic acid, a waste liquor container and a recovering container, a pressure air-feeding mechanism for introducing a pressure air into the cartridge for separation and purification of nucleic acid, and a mechanism for separately injecting the washing solution and the recovering solution into the cartridge for separation and purification of nucleic acid and wherein the steps of separating and purifying nucleic acids are automatically conducted in a short time with good efficiency in such manner that a nucleic acid-containing sample solution is injected into the cartridge for separation and purification of nucleic acid containing a nucleic acid-adsorbing membrane, an increased pressure condition is created to adsorb nucleic acids in the sample solution to the nucleic acid-adsorbing porous membrane, a washing solution is injected into the cartridge for separation and purification of nucleic acid, an increased pressure condition is created to wash out impurities, a recovering solution is injected into the cartridge for separation and purification of nucleic acid to desorb the nucleic acids adsorbed to the nucleic acid-adsorbing porous membrane and recover them.

When the holding mechanism is constituted to have a stand, a cartridge holder vertically movably supported on the stand and holding the cartridge for separation and purification of nucleic acid, and a holder for exchangeably holding the waste liquor container and the recovering container, it can easily be conducted to set the cartridge for separation and purification of nucleic acid and the two containers and exchange the waste liquor container and the recovering container with each other.

Also, when the pressure air-feeding mechanism is constituted to have an air nozzle, a pressure head for vertically moving the air nozzle, and a positioning means functioning to position the cartridge for separation and purification of nucleic acid, feeding of the pressure air is secured through a simple mechanism.

Also, when the separately injecting mechanism is constituted to have a washing solution-injecting nozzle for injecting the washing solution, a recovering solution-injecting nozzle for injecting the recovering solution, a nozzle-shifting rack capable of migrating in sequence over the cartridges for separation and purification of nucleic acid, a washing solution-feeding pump for sucking the washing solution from a bottle containing the washing solution and feeding the washing solution to the washing solution-injecting nozzle, and a recovering solution-feeding pump for sucking the recovering solution from a bottle containing the recovering solution and feeding the recovering solution to the recovering solution-feeding nozzle, injection of the washing solution and the recovering solution can be conducted in sequence through a simple mechanism.

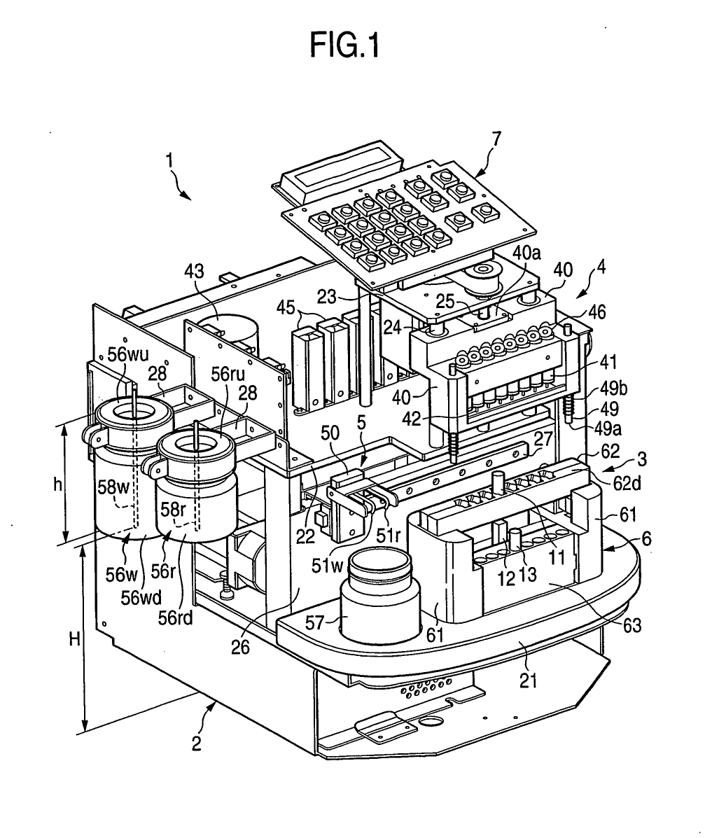

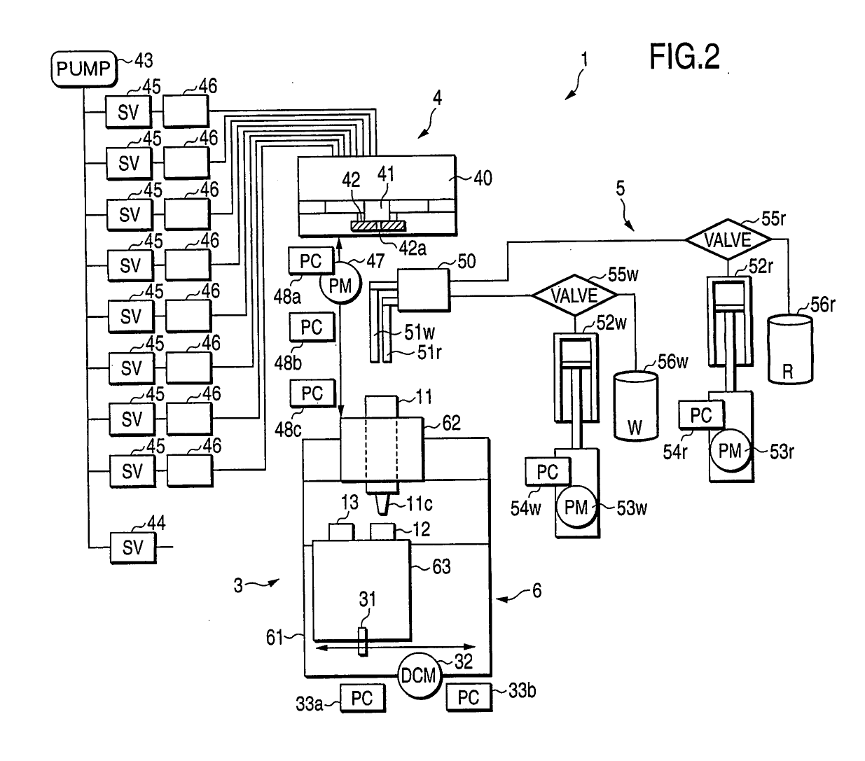

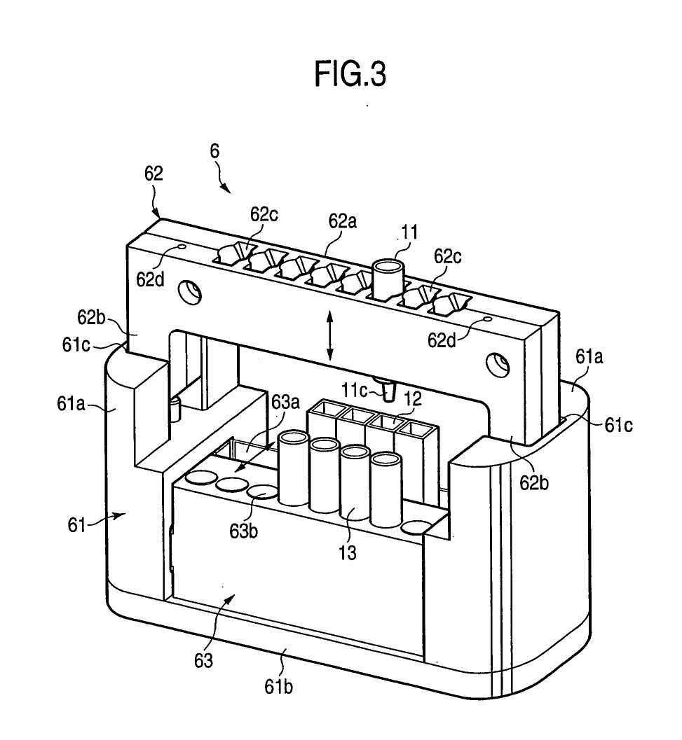

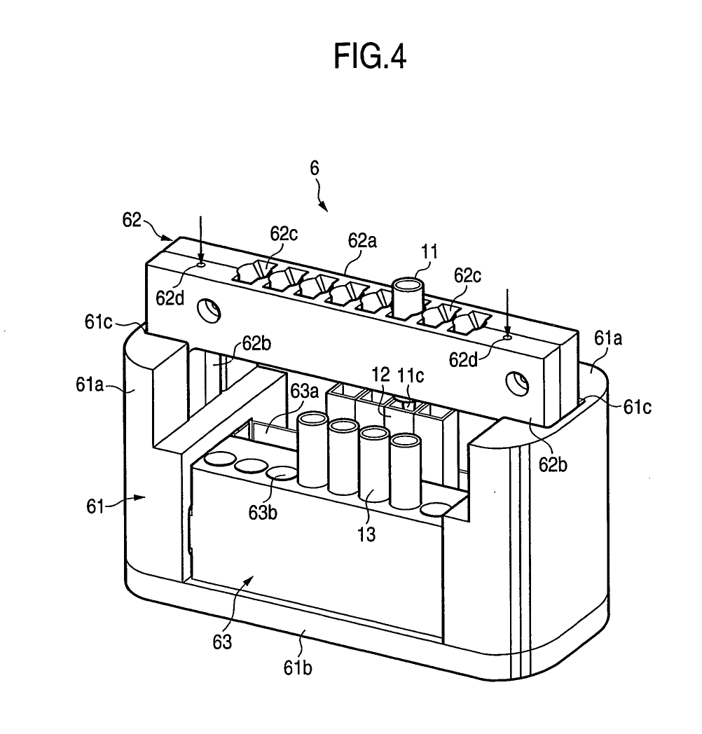

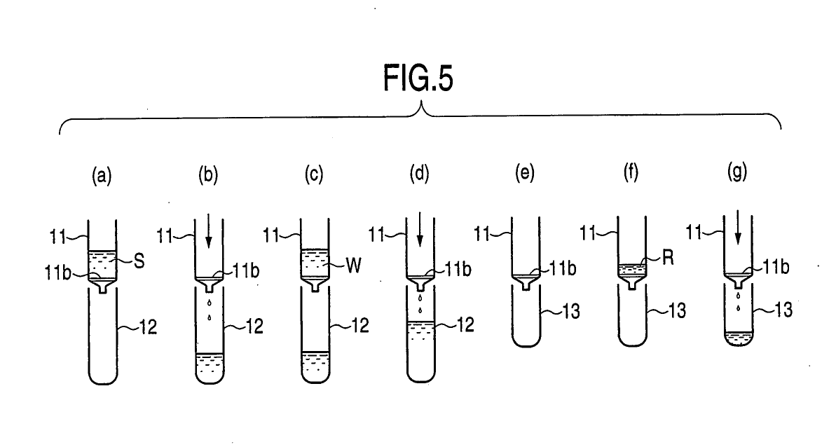

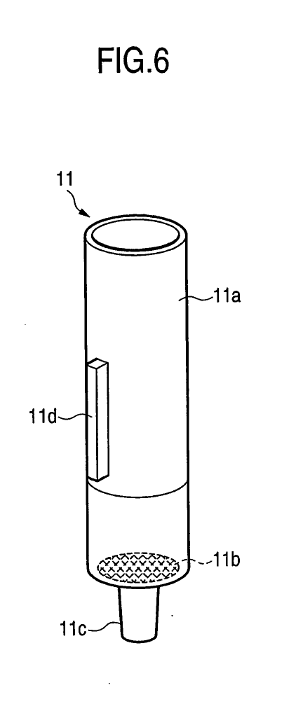

An embodiment of the automatic apparatus is illustrated below by reference to drawings. FIG. 1 is a perspective view showing the nucleic acid-extracting apparatus of one embodiment of the invention with the cover being removed. FIG. 2 is an outline diagram of the automatic apparatus. FIG. 3 is a perspective view showing the rack in the holding mechanism. FIG. 4 is a perspective view showing the state of the rack under use. FIG. 5 is a diagram showing the progress of operation. FIG. 6 is a perspective view showing the cartridge for separation and purification of nucleic acid.

The automatic apparatus 1 of one embodiment of the invention is an apparatus for extracting nucleic acids from a sample solution containing them using a cartridge 11 for separation and purification of nucleic acid as shown in FIG. 6 (a cartridge containing a nucleic acid-adsorbing porous membrane). In this cartridge 11 for separation and purification of nucleic acid, the nucleic acid-adsorbing porous membrane member 11b is held at the bottom of the cylindrical body 11a having an opening at the upper end, the portion of the cylindrical body 11a lower than the nucleic acid-adsorbing porous membrane member 11b is shaped in a funnel-like form, a discharging portion 11c of a fine pipe nozzle shape is projectively formed with a predetermined length at the center of the lower end, and a vertical projection 11d is formed on both sides of the cylindrical body 11a. A sample solution, a washing solution and a recovering solution to be described hereinafter are successively injected through the upper opening, a pressure air is introduced through the upper opening, and each solution flows downward through the nucleic acid-adsorbing porous membrane member 11b and is discharged through the discharging portion 11c into the waste liquor container 12 or the recovering container 13. Additionally, in the drawing, the cylindrical body 11a has the structure wherein an upper portion and a lower portion are engaged with each other.

In the automatic apparatus 1, separation and purification of nucleic acids are conducted according to the nucleic acid-separating and separating process as shown in FIG. 5(a) to (g). First, in step (a) in FIG. 5, a sample solution S having been subjected to the solubilizing treatment is injected into the cartridge 11 for separation and separation of nucleic acid positioned over the waste liquor solution 12. Then, in step (b) in FIG. 5, a pressure air is introduced into the cartridge 11 for separation and purification of nucleic acid to apply pressure and pass the sample solution S through the nucleic acid-adsorbing porous membrane member 11b for adsorbing nucleic acids to the nucleic acid-adsorbing porous membrane, and the passed liquid component is discharged into the waste liquor container 12.

Then, in step (c) in FIG. 5, a washing solution W is automatically injected into the cartridge 11 for separation and purification of nucleic acid and, in step (d), a pressure air is introduced into the cartridge for separation and purification of nuclei to wash out other impurities with leaving nucleic acids in a state of being adsorbed on the nucleic acid-adsorbing porous membrane member 11b, and the washing solution W having passed through the porous membrane is discharged into a waste liquor container 12. The step (c) and the step (d) may be repeated plural times.

Thereafter, in step (e), the waste liquor container 12 positioned beneath the cartridge 11 for separation and purification of nucleic acid is exchanged for a recovering container 13 and, in step (f), a recovering solution R is automatically injected into the cartridge 11 for separation and purification of nucleic acid and, in step (g), a pressure air is introduced into the cartridge 11 for separation and purification of nucleic acid to weaken binding force between the nucleic acids-adsorbing porous membrane member 11b and nucleic acids and desorb the adsorbed nucleic acids, with the recovering solution R containing nucleic acids being discharged into the recovering container 13 to recover.

As is shown in FIGS. 1 and 2, the automatic apparatus 1 comprises a main body 2 equipped with a holding mechanism 3 which holds a plurality of cartridges 11 for separation and purification of nucleic acid, a waste liquor container 12 and a recovering container 13, a pressure air-feeding mechanism 4 for introducing a pressure air into the cartridge 11 for separation and purification of nucleic acid, and an separately injecting mechanism 5 for successively injecting a washing solution W and a recovering solution R. Each of the mechanisms 3 to 5 is specifically described below.

<Holding Mechanism>

The holding mechanism 3 has a mounting platform 21 in front of and at a lower part of the main body of the apparatus, on which platform is mounted a rack 6 holding a plurality of the cartridges 11 for separation and purification of nucleic acid, the waste liquor container 12 and the recovering container. 13. As is also shown in FIG. 3, the rack 6 has a stand 61, a cartridge holder 62 and a container holder 63. The stand 61 vertically movably holds the cartridge holder 62 in pillars 61a on both sides and holds back-and-forth movably the container holder 63 at the lower portion between the pillars 61a on the bottom plate 61b.

The cartridge holder 62 is constituted by two plate members joined to each other and has supporting legs 62b extending in the vertical direction at the both ends of a holding part 62a extending in the transverse direction. The supporting legs 62b are vertically movably inserted into sliding grooves 61c formed in each of the pillars 61a of the stand 61. The supporting legs 62b are pushed upward by means of a pushing member (not shown) contained in the stand 61. In the holding part 62a are juxtaposed a plurality of holding holes 62c, the cartridges 11 for separation and purification of nucleic acid are inserted from above, and the lower end of the projections 11d (see FIG. 6) formed on both sides of the cylindrical body 11a of each cartridge 11 for separation and purification of nucleic acid is engaged with an engaging member (not shown) inside the cartridge holder 62 to hold the cartridge. The engaging member is movable and, after moving, engagement with the projections 11d is released to allow all cartridges 11 for separation and purification of nucleic acid to fall downward at the same time to discard.

This cartridge holder 62 has pin holes 62d on both sides of the upper surface and, under operation, a tip 49a of a press pin 49 (see FIG. 1) functioning as a positioning means to e described hereinafter is engaged with each pin hole 62d to press the cartridge holder 62 downward. The mechanism is designed so that, when the cartridge holder 62 is in a lifted position As is shown in FIG. 3, the lower end of the discharge portion 11c of the cartridge 11 for separation and purification of nucleic acid is positioned above the waste liquor container 12 and the recovering container 13 set in the container holder 63 but, when the cartridge holder 62 goes down to the lower position as is shown in FIG. 4, the discharge portion 11c of the cartridge 11 for separation and purification of nucleic acid is inserted into the inside of the waste liquor container 12 or the recovering container 13 to a predetermined degree.

The container holder 63 has waste liquor container-holding holes 63a and recovering container-holding holes 63b arranged in the transverse direction in two parallel rows, and a plurality of waste liquor containers 12 are held in a row in the rear side waste liquor container-holding holes 63a, whereas a plurality of recovering containers 13 are held in a row in the front side recovering container-holding holes 63b. The waste liquor container-holding holes 63a and the recovering container-holding holes 63b are provided at the same pitch as that of cartridge-holding holes 62c of the cartridge holder 62, and the waste liquor container 12 and the recovering container 13 are positioned so that they are respectively beneath each of the cartridges 11 for separation and purification of nucleic acid held in the cartridge holder 62. In order to avoid confusion of the waste liquor container 12 with the recovering container 13, they are preferably different from each other in, for example, size or shape.

The container holder 63 is pressed forward by means of a pressing member (not shown) contained within the stand 61. Movement of the container holder 63 for exchanging the containers (back-and-forth movement) is conducted by engaging a working member 31 (see FIG. 2) provided in the mounting platform 21 with an engaging hole (not shown) in the bottom of the container holder 63 through the opening formed in the bottom plate 61b of the stand 61. The container holder 63 is moved backward in proportion to the moving operation of the working member 31 corresponding to the drive of a container-exchanging motor 32 (DC motor) so that the recovering container 13 comes beneath the cartridge holder 62. When not working, the waste liquor container 12 is pressed to come beneath the cartridge holder 62 by means of a pressing member not shown. Operation of the container-exchanging motor 32 is controlled based on detected signals from position sensors 33a and 33b.

<Pressure Air-Feeding Mechanism>

As is shown in FIGS. 1 and 2, the pressure air-feeding mechanism 4 has a pressure head 40 vertically movable with respect to the rack 6 of the holding mechanism 3, a plurality of air nozzles 41 (8 nozzles in FIG. 1 or 2) arranged in a row in the pressure head 40, an air pump 43 for generating a pressure air, a relief valve 44, on-off valves 45 provided for respective air nozzles 41 and individually on-off operable, and pressure sensors 46 provided for respective air nozzles 41, and feeds a pressure air successively to the cartridges 11 for separation and purification of nucleic acid.

The pressure head 40 is vertically movably held by guide rods 24 vertically provided between an intermediate frame 22 and an upper frame 22 of the main body 2 of the apparatus. Similarly, a ball nut 40a provided in the pressure head 40 is screwed to a ball screw 25 provided in a vertical direction, and the pressure head 40 is vertically moved by rotation of the ball screw 25 through the timing belt and the pulley driven by a vertically moving motor 47 (pulse motor) according to signals detected by photosensors 48a to 48c. The pressure head 40 has pressing pins 49 on both sides thereof, and the pressing pins 49 are vertically movable by being pushed downward by a spring 49b, with the tip 49a being engaged with the pin holes 62d on the upper surface of the cartridge holder 62 so as to pressingly restrict the position.

The pressing pins 49 are provided so that, under pressing operation, the cartridge holder 62 is pressed at the front side thereof without interfering with the transverse migration of the washing solution-injecting nozzles 51w and recovering solution-injecting nozzles 51r to be described hereinafter.

The air nozzles 41 are vertically movably provided in the pressure head 40 with being pressed downward, and sheet-shaped sealing member 42 having communicating pores 42a (see FIG. 2) corresponding to the air nozzles 41 is provided beneath the air nozzles 41 and, upon the pressure head 40 is moved downward, the top end of each of the air nozzles 41 presses the upper end opening of the cartridge 11 for separation and purification of nucleic acid set in the cartridge holder via the sealing member 42 to seal up the cartridge 11, thus a pressure being able to be fed into the cartridges 11 for separation and purification of nucleic acid thorough the communication pores 42a.

The relief valve 44 is opened to the atmosphere upon discharging the air in the passage between the air pump 43 and the on-off valve 45. The air circuit is constituted so that the on-off valve 45 is selectively opened to introduce the pressure air from the air pump 43 into the cartridge for separating and purifying nucleic acid through a corresponding air nozzle 41. The pressure sensors 46 are provided for respective air nozzles 41 for individually detecting the inside pressure of the cartridges 11 for separation and purification of nucleic acid. The mechanism is controlled so that, when the detected pressure reaches a predetermined level (e.g., 100 kPa), the corresponding on-off valve 45 is closed to stop feed of the pressure air or, when the detected pressure is reduced to a predetermined level or lower than that, completion of discharge of a solution is judged.

<Separately Injecting Mechanism>

The separately injecting mechanism 5 has a washing solution-injecting nozzle 51w and a recovering solution-injecting nozzle 51r provided in the nozzle-shifting rack 50 which can move in the transverse direction on the rack 6, a washing solution-feeding pump 52w for feeding the washing solution W contained in the washing solution bottle 56w to the washing solution-injecting nozzle 51w, a recovering solution-feeding pump 52r for feeding the recovering solution R contained in the recovering solution bottle 56r to the recovering solution-injecting nozzle 51r, and a waste liquor bottle 57 mounted on the holding platform 21.

The nozzle-shifting rack 50 can move in the transverse direction with being held on a guide rail 27 provided on the vertical wall of the main body 2 of the apparatus in a horizontal direction, and its movement is controlled by a nozzle-shifting motor (pulse motor) not shown so that the nozzle successively stops above each cartridge 11 for separation and purification of nucleic acid and, in a reset state, it stops above the waste liquor bottle 57. The washing solution-injecting nozzle 51w and the recovering solution-injecting nozzle 51r have a tip bent downward, the washing solution-injecting nozzle 51w is connected to the washing solution-feeding pump 52w via a change-over valve 55w, the washing solution-feeding pump 52w is connected to the washing solution bottle 56w via a change-over valve 55w, the recovering solution-injecting nozzle 51r is connected to the recovering solution-feeding pump 52r via a change-over valve 55r, and the recovering solution-feeding pump 52r is connected to the recovering solution bottle 56r via a change-over valve 55r. The washing solution-feeding pump 52w and the recovering solution-feeding pump 52r are constituted by a syringe pump, and the piston member of each pump is controllably driven by a pump motor 53w or 53r (pulse motor) so that a predetermined amount of the washing solution W or the recovering solution R is injected according to the position detected by the sensors 54w or 54r.

That is, in the case of injecting the washing solution W or the recovering solution R, the change-over valve 55w or 55r is changed to the side of the washing solution bottle 56w or to the side of the recovering solution bottle 56r, the pump motor 53w or 53r is driven to move backward the piston member of the washing solution-feeding pump 52w or of the recovering solution—feeding pump 52r to thereby suck the washing solution W or the recovering solution R into the inside of the washing solution-feeding pump 52w or the recovering solution-feeding pump 52r, and subsequently, the change-over valve 55w or 55r is changed to the side of the washing solution-injecting nozzle 51w or to the side of the recovering solution-injecting nozzle 51r, the pump motor 53w or 53r is driven to push-on move the piston member of the washing solution-feeding pump 52w or the recovering solution-feeding pump 52r to eject the washing solution or the recovering solution through the washing solution-injecting nozzle 51w or the recovering solution-injecting nozzle 51r till the air within the passage to the waste liquor bottle 57 is discharged, then driving of the washing solution-feeding pump 52w or the recovering solution-feeding pump 52r is stopped. Thereafter, the washing solution-injecting nozzle 51w or the recovering solution-injecting nozzle 51r is moved to the position above the cartridge 11 for separation and purification of nucleic acid, and the driving amount of the washing solution-feeding pump 52w or the recovering solution-feeding pump 52r is controlled to inject a predetermined amount of the washing solution W or the recovering solution R into the cartridge 11 for separation and purification of nucleic acid.

The washing solution bottle 56w and the recovering solution bottle 56r respectively comprise a container itself 56wb or 56rb, and a cap 56wu or 56ru. To the both caps 56wu and 56ru are provided respectively fine pipe-shaped sucking tubes 58w and 58r, and the lower end of each of the sucking tubes 58w and 58r has an opening in the vicinity of the bottom of the container 56wb or 56rb so as to suck the washing solution W or the recovering solution R corresponding to operation of the washing solution-feeding pump 52w or the recovering solution-feeding pump 52r. Also, the caps 56wu and 56ru have pipes (or openings) not shown for introducing air corresponding to the sucking operation. Additionally, since the amount of the washing solution to be used is larger than that of the recovering solution, the height of the container 56wb of the washing solution bottle 56w is larger than that of the container 56wb of the recovering solution bottle 56r and, in response to that, the sucking tube 58w is longer than the sucking tube 58r. The screw on the top of the bottle corresponding to the cap 56wu has the same diameter as that of the screw on the top of the bottle corresponding to the cap 56ru.

The both bottles 56w and 56r are mounted to the body 2 of the apparatus by respectively fitting the caps 56wu and 56ru, to which the sucking tubes 58w and 58r are respectively fixed, to the middle frame 22 of the body 2 using respectively catchers 28 and 28. The containers 56wb and 56rb are respectively screwed into the fitted caps 56wu and 56ru from under the caps with inserting the sucking tubes 58w and 58r into the top thereof. This constitution is employed to avoid such result that, when the caps 56wu and 56ru respectively having the sucking tubes 58w and 58r are removed from the containers 56wb and 56rb to replenish the washing solution W and the recovering solution R and the caps 56wu and 56ru are placed on a table or the like, a substance might adhere to the tip of the tube 58w or 58r and stain the washing solution W or the recovering solution R.

Particularly with the washing bottle 56w having a large height, the distance between the lower end of the sucking tube 58w with the container 56wb being removed and the surface of the table mounting the body 2 of the apparatus, H, is designed to be larger than the height h of the container 56wb. That is, the cap 56wu must be fitted by the catcher 28 at a position about at least two times higher than the height, h, of the container 56wb from the table surface. Such constitution permits to easily exchange the container 56wb and replenish the solution regardless of the fixed cap 56wu equipped with the sucking tube 58w. The same applies to the recovering solution bottle 56r.

Next, the mechanisms 3 to 5 described above are operated in response to the input operation of the operating panel 7 provided at the upper portion of the body 2 of the apparatus, based on the program contained in a coordinated controlling unit not shown.

The operation of separating and purifying nucleic acid using the above-described apparatus 1 for separation and purification of nucleic acid is specifically described below. First, the cartridges 11 for separation and purification of nucleic acid are set in the cartridge holder 6 in the rack 6 of the holding mechanism 3, the waste liquor container 12 and the recovering container 13 are set in the container holder 63 and the rack 6 is mounted on the holding platform 21 of the body 2 of the apparatus. Then, a solubilization-treated sample solution S is successively injected into respective cartridges 11 for separation and purification of nucleic acid. Additionally, the sample solution may be previously injected into the cartridges 11 for separation and purification of nucleic acid after or before setting the cartridges 11 in the rack 6 not mounted on the apparatus 1.

Then, the apparatus is operated by using the operating panel 7. The pressure head 40 is moved downward by driving the vertically moving motor 47 of the pressure air-feeding mechanism 4, and the front end 49a of the pressing pin 49 engages with the pin hole 62d of the cartridge holder 62 to restrict the position and, at the same time, the lower discharge portion 11c of the cartridge 11 for separation and purification of nucleic acid is inserted to a predetermined degree into the inside of the waste liquor container 12 as shown in FIG. 4 to avoid scattering of the discharged solution and contamination therewith. Then, the pressure head 40 is further moved downward so that the lower end of each air nozzle 41 can press the upper opening of the cartridge 11 for separation and purification of nucleic acid via the sealing member 42. Since the pressing pin 49 restricts the position of the cartridge holder 62, each air nozzle 41 accurately presses the cartridge 11 for separation and purification of nucleic acid, thus sufficient sealing being secured.

Subsequently, a pressure air is fed the air pump 43 is driven with the whole on-off valves 45 being closed, then the first on-off valve 45 is opened. The pressure air from the air pump 43 is fed into the first cartridge 11 for separation and purification of nucleic acid through the first air nozzle 41 and, when an increase in pressure to a predetermined level is detected by the pressure sensor 46, the first on-off valve is closed. Subsequently, the second on-off valve 45 is opened, and the pressure air is fed into the second cartridge 11 for separation and purification of nucleic acid through the second air nozzle 41. These operations are successively repeated till pressure is applied to the whole cartridges 11 for separation and purification of nucleic acid. The pressure-applied sample solution S passes through the nucleic acid-adsorbing porous membrane member 11b to thereby adsorb nucleic acids to the member 11 and discharge other ingredients into the waste liquor container 12 through the discharge portion 11c at the lower position. When all of the sample solutions S are passed through the nucleic acid-adsorbing porous membrane member 11b, the pressure is reduced to a level of the pressure upon completion of discharge of the solution or lower than that and, when completion of adhesion of nucleic acids in all the cartridges 11 for separation and purification of nucleic acid is detected by each pressure sensor 46, the pressure head is moved upward.

Then, the stage shifts to the washing treatment. The upward movement of the pressure head 40 after feeding the pressure air is stopped when the air nozzles 41 are separated from the cartridge 11 for separation and purification of nucleic acid and moved to the height which permits movement of the nozzle-shifting rack. The pressing pin 49 presses the cartridge holder 62, and the lower end of the cartridge 11 for separation and purification of nucleic acid is inserted in the inside of the waste liquor container 12 as shown in FIG. 4. The washing treatment is conducted with keeping this state. The nozzle-shifting rack 50 is moved then stopped so that the washing solution-injecting nozzle 51w reaches the position over the first cartridge 11 for separation and purification of nucleic acid, then the washing solution W is injected in a predetermined amount. The nozzle-shifting rack is then moved to the next cartridge 11 for separation and purification of nucleic acid, and the washing solution W is successively injected. When injection of the washing solution W into all of the cartridges 11 for separation and purification of nucleic acid is completed, the pressure head 40 is moved downward, and the lower end of each air nozzle 41 presses the upper opening of each cartridge 11 for separation and purification of nucleic acid via the sealing member 42. Then, as in the foregoing step, the on-off valves 45 are successively opened to feed the pressure air to the respective cartridges 11 for separation and purification of nucleic acid. The pressure-applied washing solution W passes through the nucleic acid-adsorbing porous membrane member 11b to wash out impurities other than nucleic acids, and is discharged into the waste liquor container 12 through the discharge portion 11c at the lower portion. When the-whole washing solution W is discharged through the nucleic acid-adsorbing porous membrane member 11b in every cartridge 11 for separation and purification of nucleic acid, the pressure head 40 is moved upward to the initial position. In the case of conducting the washing treatment plural times, the above-described procedures are repeated.

Then, the stage shifts to the recovering treatment. First, after the pressing pin 49 is moved upward along with the cartridge holder 62 in the rack 6 and the discharge portion 11c at the lower portion of the cartridge for separation and purification of nucleic acid is moved above the waste liquor container 12 by the upward movement of the pressure head 40 after completion of the washing treatment, the working member 31 of the holding mechanism 3 is operated to move the container holder backward so as to position the recovering container 13 beneath the cartridge 11 for separation and purification of nucleic acid, thus the containers being exchanged.

Subsequently, the pressure head 40 is moved downward, and the front end of the pressing pin 49 engages with the pin hole 62d of the cartridge holder 62 to press the holder, whereby the lower end of the cartridge 11 for separation and purification of nucleic acid is held in a state of being inserted into the recovering container 13. Then, the nozzle-shifting rack 50 is moved then stopped so that the recovering solution-injecting nozzle 51r reaches the position above the first cartridge 11 for separation and purification of nucleic acid. A predetermined amount of the recovering solution W is injected into the first cartridge, then the nozzle-shifting rack 50 is moved to the next cartridge 11 for separation and purification of nucleic acid, and injection of the recovering solution R is successively conducted. When injection of the recovering solution R into all of the cartridges 11 for separation and purification of nucleic acid is completed, the pressure head 40 is further moved downward as described hereinbefore, and the lower end of each air nozzle 41 presses the upper opening of each cartridge 11 for separation and purification of nucleic acid via the sealing member 42. Then, the on-off valves 45 are successively opened to feed the pressure air to the respective cartridges 11 for separation and purification of nucleic acid. The pressure-applied recovering solution R passes through the nucleic acid-adsorbing porous membrane member 11b to desorb nucleic acids adsorbed to the member 11, and is discharged into the recovering container 13 through the discharge portion 11c at the lower portion. When the whole recovering solution R in the cartridges 11 for separation and purification of nucleic acid is discharged, the pressure head 40 is moved upward, thus a series of operations being completed.

After completion of the separation and purification, the rack 6 is demounted from the mounting platform 21, and the cartridges 11 for separation and purification of nucleic acid and the waste liquor container 12 are taken out of the cartridge holder 62 and the container holder 63, respectively, and discarded. On the other hand, the recovering containers 13 are taken out of the container holder 63 and, if necessary, a lid is put on each cartridge, and is then subjected to, for example, subsequent treatment for analysis of nucleic acid.

Additionally, in this embodiment, a plurality of cartridges 11 for separation and purification of nucleic acid are used, but the invention is not limited only to that, and the treatment can be applied to only one cartridge 11.

The invention will hereinafter be described in more detail by Examples, but the invention is not limited to these Examples.

### EXAMPLE 1

(1) Preparation of a Cartridge for Purification of Nucleic Acid

A container for a cartridge for separation and purification of nucleic acid, which has a portion for containing a nucleic acid-adsorbing porous membrane and which has an inner diameter of 7 mm, was made of high-impact polystyrene. As the nucleic acid-adsorbing porous membrane of a mixture of acetylcelluloses different from each other in actyl value, a porous membrane of a mixture of triacetylcellulose and diacetylcellulose with a mixing ratio of 6:4 (thickness=70 μm, average pore size=1.2 μm) was contained in the portion of the container for the cartridge for separation and purification of nucleic acid adapted for containing the nucleic acid-adsorbing porous membrane to prepare a cartridge for separation and purification of nucleic acid.

(2) Preparation of a Nucleic Acid-Solubilizing Reagent (for RNA) and a Washing Solution

A nucleic acid-solubilizing reagent solution and a washing solution having the formulation shown in Table 1 were prepared.

TABLE 1
(Nucleic acid-solubilizing reagent solution)

| | |
|---|---|
| guanidine hydrochloride (Life Technologies, Inc.) | 382 g |
| Tris (Life Technologies, Inc.) | 12.1 g |
| Triton X-100 (ICN) | 10 g |
| distilled water | 1000 ml |

(Washing solution)

100 mM NaCl
10 mM Tris-HCl
65% ethanol

(3) Procedures for Separating and Purifying Nucleic Acids

A culture solution of human myeloma cells (HL60) was prepared. This culture solution was collected in an amount containing 1×10⁶ cells, and was subjected to centrifugal operation for 5 minutes to precipitate the cells, followed by removing the supernatant to obtain cells. 200 μg of the RNA-solubilizing reagent solution was added to the HL60 cells (1×10⁶), followed by stirring. Subsequently, 200 μl of ethanol was added, and the resulting mixture was stirred to prepare a sample solution containing RNA. The RNA-containing sample solution was injected into a cartridge for separation and purification of nucleic acid containing a nucleic acid-adsorbing porous membrane of a mixture of acetylcellulose different from each other in acetylation degree through one opening thereof. Then, a pressure generator was connected to the opening, and an increased pressure condition was created within the cartridge for separation and purification of nucleic acid to thereby pass the injected RNA-containing sample solution through the nucleic acid-adsorbing porous membrane and allow the sample solution to come into contact with the nucleic acid-adsorbing porous membrane, followed by discharging the sample solution through the other opening of the cartridge for separation and purification of nucleic acid. Subsequently, the washing solution was injected into the cartridge for separation and purification of nucleic acid through the one opening thereof, the pressure generator was connected to the one opening of the cartridge for separation and purification of nucleic acid, and an increased pressure condition was created within the cartridge for separation and purification of nucleic acid to thereby pass the injected washing solution through the nucleic acid-adsorbing porous membrane, followed by discharging the washing solution through the other opening of the cartridge. Subsequently, a recovering solution was injected through the one opening thereof, the pressure generator was connected to the one opening of the cartridge for separation and purification of nucleic acid, and an increased pressure condition was created within the cartridge for separation and purification of nucleic acid to thereby pass the injected recovering solution through the nucleic acid-adsorbing porous membrane, followed by discharging the washing solution through the other opening of the cartridge to recover the solution.

(4) Confirmation of Separation and Purification of RNA

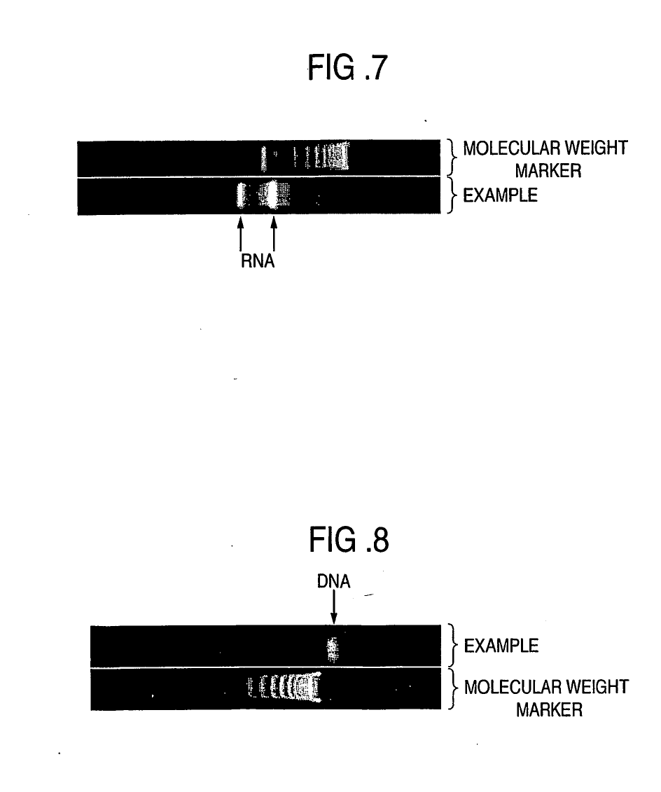

The recovering solution was subjected to agarose gel electrophoresis. The results are shown in FIG. 7 (marker in FIG. 7: READY-LOAD (trade name); 1 kb Plus NA Ladder). As is seen from the results shown in FIG. 7, RNA can be separated and purified with a good recovering efficiency by using the cartridge for separation and purification of nucleic acid containing the nucleic acid-adsorbing porous membrane comprising a mixture of acetylcelluloses different from each other in acetyl value and a pressure generator.

### EXAMPLE 2

(1) Preparation of a Cartridge for Separation and Purification of Nucleic Acid

A nucleic acid-adsorbing porous membrane obtained by saponification treatment of a porous membrane (thickness=70 μm; average pore size=50 μm) obtained from a mixture of triacetylcellulose and diacetylcellulose (mixing ratio=6:4) was used as a nucleic acid-adsorbing porous membrane obtained by saponification treatment of a porous membrane obtained from a mixture of acetylcelluloses different in acetyl value, and was contained in a portion of the container for the cartridge prepared in Example 1 and having an inner diameter of 7 mm and the portion for containing the nucleic acid-adsorbing porous membrane to prepare a cartridge for separation and purification of nucleic acid.

The above-described saponification treatment was conducted by dipping a porous membrane of a mixture of triacetylcellulose and diacetylcellulose (mixing ratio=6:4) in a 2N sodium hydroxide aqueous solution for 20 minutes. The average pore size of the porous membrane was reduced from 5.0 μm to 2.5 μm after the treatment.

(2) Procedures for Separating and Purifying Nucleic Acid

200 μl of the nucleic acid-solubilizing reagent prepared in Example 1 and 20 μl of a protease (SIGMA; “Protease” Type XXIV Bacterial) solution were added to 200 μl of a human whole blood sample, and the mixture was incubated for 10 minutes at 60° C. After inculation, 200 μl of ethanol was added and the mixture was stirred to prepare a sample solution containing nucleic acids. The sample solution containing nucleic acids was injected into the cartridge prepared in (1) and containing the nucleic acid-adsorbing porous membrane made of a saponification product of a mixture of acetylcellulose different from each other in acetyl value through one opening thereof. Subsequently, a pressure generator was connected to the one opening, and an increased pressure condition was created within the cartridge to pass the injected sample solution containing nucleic acids through the nucleic acid-adsorbing porous membrane, whereby the sample solution was allowed to come into contact with the nucleic acid-adsorbing porous membrane. Then, the sample solution was discharged through the other opening of the cartridge for separation and purification of nucleic acid. Subsequently, the washing solution prepared in Example 1 was injected into the cartridge for separation and purification of nucleic acid through the one opening thereof, the pressure generator was connected to the one opening of the cartridge for separation and purification of nucleic acid, and an increased pressure condition was created within the cartridge for separation and purification of nucleic acid to thereby pass the injected washing solution through the nucleic acid-adsorbing porous membrane, followed by discharging the washing solution through the other opening of the cartridge. Subsequently, a recovering solution was injected into the cartridge for separation and purification of nucleic acid through the one opening thereof. Then, a pressure generator was connected to the one opening, and an increased pressure condition was created within the cartridge to pass the injected recovering solution through the nucleic acid-adsorbing porous membrane, and the recovering solution was discharged through the other opening of the cartridge for separation and purification of nucleic acid to recover the solution.

(3) Confirmation of Separation and Purification of Nucleic Acids

The recovering solution was subjected to agarose gel electrophoresis. The results are shown in FIG. 8 (marker: the same as in FIG. 7). It is seen that nucleic acids can be separated and purified with a good recovering efficiency by using the cartridge for separation and purification of nucleic acid containing the nucleic acid-adsorbing porous membrane comprising a saponification product of a mixture of acetylcelluloses different from each other in acetyl value and a pressure generator.

### EXAMPLE 3

(1) Preparation of a Cartridge for Purification of Nucleic Acid

A container for a cartridge for separation and purification of nucleic acid, which had a portion for containing a nucleic acid-adsorbing porous membrane and which has an inner diameter of 7 mm, was made of high-impact polystyrene.

As the nucleic acid-adsorbing porous membrane for separation and purification of nucleic acid, a porous membrane obtained by saponification treatment of a porous membrane of triacetylcellulose was used and was contained in the portion of the container for the cartridge for separation and purification of nucleic acid prepared in (1).

The above-described saponification treatment was conducted by dipping a porous membrane of triacetylcellulose in a 2N sodium hydroxide aqueous solution for 20 minutes. The average pore size of the porous membrane was reduced from 5.0 μm to 2.5 μm after the treatment.

(2) Preparation of a Nucleic Acid-Solubilizing Reagent Solution and a Washing Solution

TABLE 2
(Nucleic acid-solubilizing reagent solution)

| | |
|---|---|
| guanidine hydrochloride (Life Technologies, Inc.) | 382 g |
| Tris (Life Technologies, Inc.) | 12.1 g |
| Triton X-100 (ICN) | 10 g |
| distilled water | 1000 ml |

(Washing solution)

10 mM Tris-HCl
65% ethanol

(2) Procedures for Separating and Purifying Nucleic Acid

200 μl of the nucleic acid-solubilizing reagent and 20 μl of a protease (SIGMA; “Protease” Type XXIV Bacterial) solution were added to 200 μl of a human whole blood sample, and the mixture was incubated for 10 minutes at 60° C. After stirring, the solution was injected into the cartridge containing the nucleic acid-adsorbing porous membrane of 70 μm in thickness prepared in (1) and (2) through one opening thereof. Subsequently, a pressure difference-generating apparatus was connected to the one opening, and an increased pressure condition was created within the cartridge to pass the injected sample solution containing nucleic acids through the nucleic acid-adsorbing porous membrane, whereby the sample solution was allowed to come into contact with the nucleic acid-adsorbing porous membrane. Then, the sample solution was discharged through the other opening of the cartridge for separation and purification of nucleic acid. Subsequently, a washing solution was injected into the cartridge for separation and purification of nucleic acid through the one opening thereof. Then, a pressure difference-generating apparatus was connected to the one opening, and an increased pressure condition was created within the cartridge to pass the injected recovering solution through the nucleic acid-adsorbing porous membrane, and the injected washing solution was discharged through the other opening of the cartridge for separation and purification of nucleic acid. Subsequently, a recovering solution was injected into the cartridge for separation and purification of nucleic acid through the one opening thereof. Then, a pressure difference-generating apparatus was connected to the one opening, and an increased pressure condition was created within the cartridge to pass the injected recovering solution through the nucleic acid-adsorbing porous membrane, and the recovering solution was discharged through the other opening of the cartridge for separation and purification of nucleic acid to recover the solution.

### COMPARATIVE EXAMPLE 1

The same procedures as in Example 3 were conducted except for using as a nucleic acid-adsorbing porous membrane a 600-μm thick porous membrane in place of the 70-μm thick porous membrane.

(4) Evaluation on Time Required for Operation of Purifying Nucleic Acids

Experiments of Example 3 and Comparative Example 1 were repeated 10 times. The times required for the separating and purifying step were averaged, and the averaged time was compared with the time required when the 70 μm-thick porous membrane was used, with taking the time of the latter as 1. Results thus obtained are shown in Table 3.

TABLE 3

| | Relative |
|---|---|
| Thickness of porous | required |
| membrane [μm] | time |
| 70 | 1 |
| 600 | 10 |

As is apparent from Table 3, nucleic acids can be expeditiously recovered and purified by employing the method of the invention.

### EXAMPLE 4

The same procedures as in Example 3 were conducted except for using as a porous membrane for separation and purification of nucleic acid a 70-μm thick porous membrane of 2 or more in the ratio of the maximum pore size to the minimum pore size in place of the 70-μm thick porous membrane.

### COMPARATIVE EXAMPLE 2

The same procedures as in Example 4 were conducted except for using polymer beads of 0.2 μm in size in place of a 70-μm thick porous membrane of 2 or more in the ratio of the maximum pore size to the minimum pore size.

(1) Evaluation on Time Required for Operation of Purifying Nucleic Acids

Experiments of Example 4 and Comparative Example 2 were repeated 5 times. It was visually judged whether nucleic acids were recovered by passing the sample solution, or whether purification was impossible due to clogging, in the method for separation and purification of nucleic acid. Results thus obtained are shown in Table 4.

TABLE 4

| Number of times of | | Comparative |
|---|---|---|
| evaluation | Example 5 | Example 3 |
| 1 | ◯ | X |
| 2 | ◯ | X |
| 3 | ◯ | X |
| 4 | ◯ | X |
| 5 | ◯ | X |

◯: The solution passed, and nucleic acids were recovered.
X: Clogging occurred.

As is apparent from the results in Table 4, nucleic acids can be expeditiously recovered and purified without causing clogging by employing the method of the invention.

### EXAMPLE 5

The same procedures as in Example 3 were conducted except for using as a porous membrane for separation and purification of nucleic acid a 70-μm thick porous membrane of 70% in the void volume in place of the 70-μm thick porous membrane.

### COMPARATIVE EXAMPLE 3

The same procedures as in Example 5 were conducted except for using as a porous membrane for separation and purification of nucleic acid a 70-μm thick porous membrane of 58% or 80% in the void volume in place of the 70-μm thick porous membrane of 70% in the void volume.

(1) Evaluation on the Recovered Amount of Nucleic Acids

Experiments of Example 5 and Comparative Example 3 were repeated ten times. The amounts of nucleic acids recovered as a result of the purifying steps were averaged, and the amounts were compared with each other, with the amount of nucleic acid recovered by using a porous membrane of 70% in the void volume being taken as

1. The Results are Shown in Table 5.

Additionally, the void volume of the porous membrane was determined as a volume ratio of void in the porous membrane by comparing a postulated weight, determined by multiplying the volume determined from the cross section and the thickness of the cut-out porous membrane by the density of the substance constituting the porous membrane, with the actual weight of the membrane.

TABLE 5

| Void volume of | |
|---|---|
| porous membrane | Relative value of |
| (%) | recovered amount |
| 58 | 0.4 |
| 70 | 1 |
| 80 | 1.1 |

As is apparent from the results in Table 5, nucleic acids can be effectively recovered and purified by employing the method of the invention.

### EXAMPLE 6

The same procedures as in Example 3 were conducted except for using as a porous membrane for separation and purification of nucleic acid a 70-μm thick porous membrane of 4.5 kgf/cm² in bubble point in place of the 70-μm thick porous membrane.

### COMPARATIVE EXAMPLE 4

The same procedures as in Example 6 were conducted except for using as a porous membrane for separation and purification of nucleic acid a 70-μm thick porous membrane of 5.5 kgf/cm² or 2.0 kgf/cm² in bubble point in place of the 70-μm thick porous membrane of 4.5 kgf/cm² in bubble point.

(1) Evaluation on Time Required for Operation of Purifying Nucleic Acids

Experiments of Example 6 and Comparative Example 4 were repeated 10 times. The times required for the purifying steps were averaged, and the averaged time was relatively compared, with taking the time required when the porous membrane of 4.5 kgf/cm² in bubble point as 1. Results thus obtained are shown in Table 6.

TABLE 6

| Bubble point of | |
|---|---|
| porous membrane | Relative necessary |
| [kgf/cm²] ) | time |
| 5.5 | 1.6 |
| 4.5 | 1 |
| 2.0 | 0.4 |

As is apparent from the results in Table 6, nucleic acids can be expeditiously recovered and purified by employing the method of the invention.

### EXAMPLE 7

The same procedures as in Example 3 were conducted except for using as a porous membrane for separation and purification of nucleic acid a 70-μm thick porous membrane of 75 kPa in pressure loss in place of the 70-μm thick porous membrane.

### COMPARATIVE EXAMPLE 5

The same procedures as in Example 7 were conducted except for using as a porous membrane for separation and purification of nucleic acid a 70-μm thick porous membrane of 90 kPa or 20 kPa in pressure loss in place of the 70-μm thick porous membrane of 75 kPa in pressure loss.

(1) Evaluation on Time Required for Operation of Purifying Nucleic Acids

Experiments of Example 7 and Comparative Example 5 were repeated 10 times. The times required for the purifying steps were averaged, and the averaged time was relatively compared, with taking the time required when the porous membrane of 75 kPa in pressure loss as 1. Results thus obtained are shown in Table 7.

Additionally, the pressure loss was measured after passing the porous membrane in a dry state once through water to enough moisten with water.

TABLE 7

| Pressure loss of | |
|---|---|
| porous membrane | Relative necessary |
| [kPa] ) | time |
| 90 | 2 |
| 75 | 1 |
| 20 | 0.3 |

As is apparent from the results in Table 7, nucleic acids can be expeditiously recovered and purified by employing the method of the invention.

### EXAMPLE 8

The same procedures as in Example 3 were conducted except for using as a porous membrane for separation and purification of nucleic acid a 70-μm thick porous membrane of 60 mL/min/cm² in water penetration amount when water was allowed to pass under a pressure of 1 kg/cm² at 25° C. in place of the 70-μm thick porous membrane.

### COMPARATIVE EXAMPLE 6

The same procedures as in Example 8 were conducted except for using as a porous membrane for separation and purification of nucleic acid a 70-μm thick porous membrane of 80 or 30 mL/min/cm² in water penetration amount in place of the 70-μm thick porous membrane of 60 mL/min/cm² in water penetration amount when water was allowed to pass under a pressure of 1 kg/cm² at 25° C. in place of the 70-μm thick porous membrane.

(1) Evaluation on Time Required for Operation of Purifying Nucleic Acids

Experiments of Example 8 and Comparative Example 6 were repeated 10 times. The times required for the purifying steps were averaged, and the averaged time was relatively compared, with taking the time required when the porous membrane of 60 mL/min/cm² in water penetration amount when water was allowed to pass under a pressure of 1 kg/cm² at 25° C. as 1. Results thus obtained are shown in Table 8.

Additionally, the water penetration amount of the porous membrane was measured after passing the porous membrane in a dry state once through water to enough moisten with water. The temperature was 25° C., and the pressure of 1 kg/cm².

TABLE 8

| Water penetration | |
|---|---|
| amount of porous | |
| membrane | Relative necessary |
| [mL/(min · cm²) ] | time |
| 30 | 2 |
| 60 | 1 |
| 80 | 0.8 |

As is apparent from the results in Table 8, nucleic acids can be expeditiously recovered and purified by employing the method of the invention.

### EXAMPLE 9

The same procedures as in Example 3 were conducted except for using as a porous membrane for separation and purification of nucleic acid a 70-μm thick porous membrane of 0.9 μg/mg (weight of membrane) in the amount of adsorbed nucleic acids in place of the 70-μm thick porous membrane.

### COMPARATIVE EXAMPLE 7

The same procedures as in Example 9 were conducted except for using as a porous membrane for separation and purification of nucleic acid a 70-μm thick porous membrane of 0.5 μg/mg (weight of membrane) in the amount of adsorbed nucleic acids in place of the 70-μm thick porous membrane of 0.9 μg/mg (weight of membrane).

(1) Comparison of the Amount of Recovered Nucleic Acid when Membranes of the Same Weight are Used

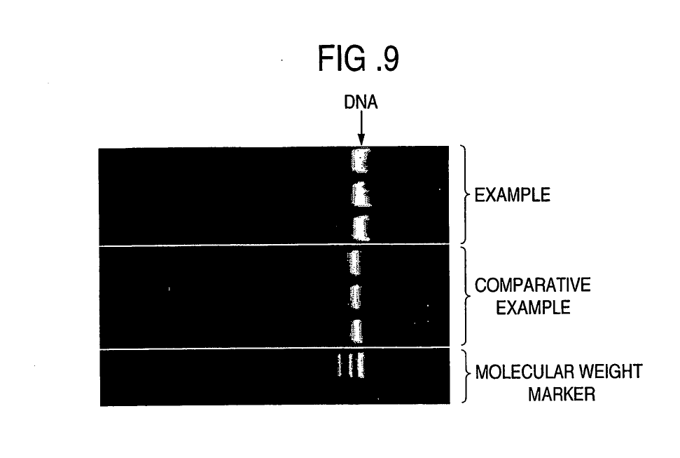

Results of electrophoresis of nucleic acids purified from sample solutions containing nucleic acids according to the method of the invention and the method of comparative example (Example 9 and Comparative Example 7) are shown in FIG. 9. Additionally, the used marker is λDNA/HindIII digest.

As is apparent from the results in FIG. 9, nucleic acids can be recovered and purified in a high yield from the same amount of a sample solution by employing the method of the invention.

### EXAMPLE 10

(1) Preparation of a Cartridge for Purification of Nucleic Acid

A container for a cartridge for separation and purification of nucleic acid, which had a portion for containing a nucleic acid-adsorbing porous membrane and which had an inner diameter of 7 mm, was made of high-impact polystyrene. As the nucleic acid-adsorbing porous membrane of a saponification product of a mixture of acetylcelluloses different from each other in actyl value, a porous membrane of a saponification product of a mixture of triacetylcellulose and diacetylcellulose with a mixing ratio of 6:4 (thickness=70 μm, average pore size=5.0 μm) was contained in the portion of the container for the cartridge for separation and purification of nucleic acid adapted for containing the nucleic acid-adsorobing porous membrane to prepare a cartridge for separation and purification of nucleic acid.

The above-described saponification treatment was conducted by dipping a porous membrane of a mixture of triacetylcellulose and diacetylcellulose (mixing ratio=6:4) in a 2N sodium hydroxide aqueous solution for 20 minutes. The average pore size of the porous membrane was reduced from 5.0 μm to 2.5 μm after the treatment.

(2) Preparation of a Nucleic Acid-Solubilizing Reagent and a Washing Solution

A nucleic acid-solubilizing reagent solution and a washing solution having the formulation shown in Table 9 were prepared.

TABLE 9
(Nucleic acid-solubilizing reagent solution)

| | |
|---|---|
| guanidine hydrochloride (Life Technologies, Inc.) | 382 g |
| Tris (Life Technologies, Inc.) | 12.1 g |
| Triton X-100 (ICN) | 10 g |
| distilled water | 1000 ml |

(Washing solution)

100 mM NaCl
10 mM Tris-HCl
70% ethanol

(3) Procedures for Separating and Purifying DNA

200 μl of the nucleic acid-solubilizing reagent prepared in Example 1 and 20 μl of a protease (SIGMA; “Protease” Type XXIV Bacterial) solution were added to 200 μl of a human whole blood sample, and the mixture was incubated for 10 minutes at 60° C. After incubation, 200 μl of ethanol was added to the solution, and the mixture was stirred to prepare a sample solution containing nucleic acids. The resultant sample solution containing nucleic acids was injected into the cartridge containing the nucleic acid-adsorbing porous membrane of a saponification product of a mixture of acetylcelluloses different from each other in acetyl value through one opening thereof. Subsequently, a pressure generator was connected to the one opening, and an increased pressure condition was created within the cartridge to pass the injected sample solution containing nucleic acids through the nucleic acid-adsorbing porous membrane, whereby the sample solution was allowed to come into contact with the nucleic acid-adsorbing porous membrane. Then, the sample solution was discharged through the other opening of the cartridge for separation and purification of nucleic acid. In this case, the time required for the sample solution to pass through the porous membrane was measured. Subsequently, a washing solution prepared in Example 1 was injected into the cartridge for separation and purification of nucleic acid through the one opening thereof. Then, a pressure generator was connected to the one opening, and an increased pressure condition was created within the cartridge to pass the injected recovering solution through the nucleic acid-adsorbing porous membrane, and the injected washing solution was discharged through the other opening of the cartridge for separation and purification of nucleic acid. Subsequently, a recovering solution was injected into the cartridge for separation and purification of nucleic acid through the one opening thereof. Then, a pressure generator was connected to the one opening, and an increased pressure condition was created within the cartridge to pass the injected recovering solution through the nucleic acid-adsorbing porous membrane, and the recovering solution was discharged through the other opening of the cartridge for separation and purification of nucleic acid to recover the solution.

(3) Confirmation of the Amount of Recovered DNA

The recovering solution was subjected to UV measurement. The amount of DNA contained in the recovering solution was determined based on absorbance at 260 nm.

### EXAMPLE 11

The same procedures as in Example 10 were conducted except for using a porous membrane obtained by saponification treatment of a porous membrane (thickness=70 μm; average pore size=3.0 μm) of a mixture of triacetylcellulose and diacetylcellulose (mixing ratio=6:4), and the time necessary for the sample solution to pass the porous membrane and the amount of DNA in the recovering solution were determined.

The above-described saponification treatment was conducted by dipping a porous membrane of a mixture of triacetylcellulose and diacetylcellulose (mixing ratio=6:4) in a 2N sodium hydroxide aqueous solution for 20 minutes. The average pore size of the porous membrane was reduced from 3.0 μm to 1.2 μm after the treatment.

### COMPARATIVE EXAMPLE 8

The same procedures as in Example 10 were conducted except for using a porous membrane obtained by saponification treatment of a porous membrane (thickness=70 μm; average pore size=0.8 μm) of a mixture of triacetylcellulose and diacetylcellulose (mixing ratio=6:4), and the time necessary for the sample solution to pass the porous membrane and the amount of DNA in the recovering solution were determined.

### COMPARATIVE EXAMPLE 9

The same procedures as in Example 10 were conducted except for using a porous membrane obtained by saponification treatment of a porous membrane (thickness=70 μm; average pore size=5.6 μm) of a mixture of triacetylcellulose and diacetylcellulose (mixing ratio=6:4), and the time necessary for the sample solution to pass the porous membrane and the amount of DNA in the recovering solution were determined.

Measured values obtained in Examples 10 and 11 and Comparative Examples 8 and 9 are shown in Table 10.

TABLE 10

| | Time necessary for | |
|---|---|---|
| | a sample solution | |
| | to pass through | |
| | porous membrane | Amount of |
| | (sec) | recovered DNA (μg) |
| Example 10 | 8 | 5.4 |
| Example 11 | 15 | 5.6 |
| Comparative | Impossible to pass | 0.0 |
| Example 8 | due to clogging | |
| Comparative | 6 | 3.4 |
| Example 9 | | |

It is seen from Table 10 that, in Examples 10 and 11 of the invention, the sample solution can pass through the porous membrane in a short time, and that a sufficient amount of DNA can be recovered.

On the other hand, in Comparative Example 8, the porous membrane suffers clogging by the ingredients contained in the sample solution, and the sample solution cannot pass through the porous membrane, thus DNA not being recovered. Also, in Comparative Example 9, though the sample solution can pass through the porous membrane in a short time, the amount of recovered DNA is not sufficient.

### EXAMPLE 12

(1) Preparation of a cartridge for Purification of Nucleic Acid

A container for a cartridge for separation and purification of nucleic acid, which had a portion for containing a nucleic acid-adsorbing porous membrane and which had an inner diameter of 7 mm, was made of high-impact polystyrene. As the nucleic acid-adsorbing porous membrane of a saponification product of a mixture of acetylcelluloses different from each other in acetyl value, a porous membrane of a saponification product of a mixture of triacetylcellulose and diacetylcellulose with a mixing ratio of 6:4 (thickness=70 μm, average pore size=5.0 μm) was contained in the portion of the container for the cartridge for separation and purification of nucleic acid adapted for containing the nucleic acid-adsorbing porous membrane to prepare a cartridge for separation and purification of nucleic acid.

The above-described saponification treatment was conducted by dipping a porous membrane of a mixture of triacetylcellulose and diacetylcellulose (mixing ratio=6:4) in a 2N sodium hydroxide aqueous solution for 20 minutes. The average pore size of the porous membrane was reduced from 5.0 μm to 2.5 μm after the treatment.

(2) Preparation of an RNA-Solubilizing Reagent and a Washing Solution

An RNA-solubilizing reagent solution and a washing solution having the formulation shown in Table 11 were prepared.

TABLE 11
(RNA-solubilizing reagent solution)

| | | |
|---|---|---|
| guanidine hydrochloride (Life Technologies, Inc.) | 382 | g |
| Tris (Life Technologies, Inc.) | 12.1 | g |
| NP-40 (Wako) | 10 | g |
| distilled water | 1000 | ml |

(Washing solution)

100 mM NaCl
10 mM Tris-HCl
56% ethanol

(3) Procedures for Separating and Purifying RNA

A culture solution of human myeloma cells (HL60) was prepared. This culture solution was collected in an amount containing 1×10⁶ cells, and was subjected to centrifugal operation for 5 minutes to precipitate the cells, followed by removing the supernatant to obtain cells. 200 μg of the RNA-solubilizing reagent solution was added to the HL60 cells (1×10⁶), followed by stirring. Subsequently, 200 μl of ethanol was added, and the resulting mixture was stirred to prepare a sample solution containing RNA. The RNA-containing sample solution was injected into a cartridge for separation and purification of nucleic acid prepared in (1) and containing a nucleic acid-adsorbing porous membrane of a mixture of acetylcellulose different from each other in acetyl value through one opening thereof. Then, a pressure generator was connected to the opening, and an increased pressure condition was created within the cartridge for separation and purification of nucleic acid to thereby pass the injected RNA-containing sample solution through the nucleic acid-adsorbing porous membrane and allow the sample solution to come into contact with the nucleic acid-adsorbing porous membrane, followed by discharging the sample solution through the other opening of the cartridge for separation and purification of nucleic acid. In this occasion, the time necessary for the sample solution to pass the porous membrane was measured. Subsequently, the washing solution was injected into the cartridge for separation and purification of nucleic acid through the one opening thereof, the pressure generator was connected to the one opening of the cartridge for separation and purification of nucleic acid, and an increased pressure condition was created within the cartridge for separation and purification of nucleic acid to thereby pass the injected washing solution through the nucleic acid-adsorbing porous membrane, followed by discharging the washing solution through the other opening of the cartridge. Subsequently, a recovering solution was injected through the one opening thereof, the pressure generator was connected to the one opening of the cartridge for separation and purification of nucleic acid, and an increased pressure condition was created within the cartridge for separation and purification of nucleic acid to thereby pass the injected recovering solution through the nucleic acid-adsorbing porous membrane, followed by discharging the washing solution through the other opening of the cartridge to recover the solution.

(4) Confirmation of the Amount of Recovered RNA

The recovered solution was subjected to UV measurement, and the amount of RNA contained in the recovering solution was determined from the absorbance (OD) at 260 nm.

### COMPARATIVE EXAMPLE 10

The same procedures as in Example 12 were conducted except for using a porous membrane obtained by saponification treatment of a porous membrane (thickness=70 μm; average pore size=0.8 μm) of a mixture of triacetylcellulose and diacetylcellulose (mixing ratio=6:4), and the time necessary for the sample solution to pass the porous membrane and the amount of RNA in the recovering solution were determined.

### COMPARATIVE EXAMPLE 11

The same procedures as in Example 12 were conducted except for using a porous membrane obtained by saponification treatment of a porous membrane (thickness=70 μm; average pore size=5.6 μm) of a mixture of triacetylcellulose and diacetylcellulose (mixing ratio=6:4), and the time necessary for the sample solution to pass the porous membrane and the amount of RNA in the recovering solution were determined.

Measured values obtained in Examples 12 and Comparative Examples 10 and 11 are shown in Table 12.

TABLE 12

| | Time necessary for | |
|---|---|---|
| | a sample solution | |
| | to pass through | |
| | porous membrane | Amount of |
| | (sec) | recovered RNA (μg) |
| Example 12 | 16 | 9.6 |
| Comparative | Impossible to pass | 0.0 |
| Example 10 | due to clogging | |
| Comparative | 9 | 6.5 |
| Example 11 | | |

It is seen from Table 12 that, in Example 12 of the invention, the sample solution can pass through the porous membrane in a short time, and that a sufficient amount of RNA can be recovered. On the other hand, in Comparative Example 10, the porous membrane suffers clogging by the ingredients contained in the sample solution, and the sample solution cannot pass through the porous membrane, thus RNA not being recovered.

Also, in Comparative Example 11, though the sample solution can pass through the porous membrane in a short time, the amount of recovered RNA is not sufficient.

1. A nucleic acid-adsorbing porous membrane for separating and purifying a nucleic acid, which comprises a nucleic acid-adsorbing solid phase for use in a method for separating and purifying the nucleic acid, the solid phase adsorbing the nucleic acid, the method comprising the steps of:
(1) adsorbing the nucleic acid to the solid phase by allowing a sample solution containing the nucleic acid to come into contact with the nucleic acid-adsorbing solid phase;
(2) washing the solid phase by allowing a washing solution to come into contact with the solid phase, while the nucleic acid is adsorbed to the solid phase; and
(3) desorbing the nucleic acid from the solid phase by allowing a recovering solution to come into contact with the solid phase.

2. The nucleic acid-adsorbing porous membrane as described in claim 1, which has a thickness of 10 μm to 500 μm.

3. The nucleic acid-adsorbing porous membrane as described in claim 1, which has an average pore size of 0.9 to 5.0 μm.

4. The nucleic acid-adsorbing porous membrane as described in claim 1, which has a front surface and a back surface asymmetrical with each other.

5. The nucleic acid-adsorbing porous membrane as described in claim 4, wherein the ratio of the largest pore size to the smallest pore size is 2 or more.

6. The nucleic acid-adsorbing porous membrane as described in claim 1, which has a void volume of 50 to 95%.

7. The nucleic acid-adsorbing porous membrane as described in claim 1, which has a bubble point of 0.1 to 10 kgf/cm².

8. The nucleic acid-adsorbing porous membrane as described in claim 1, which has a pressure loss of 0.1 to 100 kPa.

9. The nucleic acid-adsorbing porous membrane as described in claim 1, which allows water to pass therethrough in an amount of 1 to 5000 mL per minute at a temperature of 25° C. under a pressure of 1 kg/cm².

10. The nucleic acid-adsorbing porous membrane as described in claim 1, which adsorbs the nucleic acid in an amount of 0.1 μg or more per mg of the porous membrane.

11. The nucleic acid-adsorbing porous membrane as described in claim 1, which adsorbs the nucleic acid through an interaction involving substantially no ionic bond between the porous membrane and the nucleic acid.

12. The nucleic acid-adsorbing porous membrane as described in claim 11, wherein the porous membrane adsorbing the nucleic acid through the interaction involving substantially no ionic bond comprises an organic polymer having a polysaccharide structure.

13. The nucleic acid-adsorbing porous membrane as described in claim 12, wherein the porous membrane adsorbing the nucleic acid and comprising an organic polymer having a polysaccharide structure is a mixture of acetylcelluloses different from each other in acetyl value.

14. The nucleic acid-adsorbing porous membrane as described in claim 13, wherein the mixture of acetylcedlluloses different from each other in acetyl value is a mixture of triacetylcellulose and diacetylcelluolse.

15. The nucleic acid-adsorbing porous membrane as described in claim 14, wherein the mixture has a triacetylcellulose/diacetylcellulose mixing rate of 99:1 to 1:99 by weight.

16. The nucleic acid-adsorbing porous membrane as described in claim 13, wherein the mixture of acetylcedlluloses different from each other in acetyl value is a mixture of triacetylcellulose and monoacetylcelluolse.

17. The nucleic acid-adsorbing porous membrane as described in claim 13, wherein the mixture of acetylcedlluloses different from each other in acetyl value is a mixture of triacetylcellulose, diacetylcellulose and monoacetylcelluolse.

18. The nucleic acid-adsorbing porous membrane as described in claim 13, wherein the mixture of acetylcedlluloses different from each other in acetyl value is a mixture of diacetylcellulose and monoacetylcelluolse.

19. The nucleic acid-adsorbing porous membrane as described in claim 12, wherein the porous membrane comprising the polymer having the polysaccharide structure is a porous membrane comprising an organic material obtained by saponification of acetylcellulose or acetylcelluloses.

20. The nucleic acid-adsorbing porous membrane as described in claim 19, wherein saponification ratio of the acetylcellulose(s) is 5% or more.

21. The nucleic acid-adsorbing porous membrane as described in claim 20, wherein the porous membrane comprising the organic material obtained by saponification of the acetylcellulose(s) is a porous membrane comprising an organic material obtained by saponification of a mixture of acetylcelluloses different from each other in acetyl value.

22. The nucleic acid-adsorbing porous membrane as described in claim 21, wherein the mixture of acetylcelluloses different from each other in acetyl value has a saponification ratio of 5% or more.

23. The nucleic acid-adsorbing porous membrane as described in claim 21, wherein the organic material obtained by saponification of a mixture of acetylcelluloses different from each other in acetyl value is a saponification product of a mixture of triacetylcellulose and diacetylcellulose.

24. The nucleic acid-adsorbing porous membrane as described in claim 23, wherein the triacetylcellulose/diacetylcellulose mixing ratio is 99:1 to 1:99 by weight.

25. The nucleic acid-adsorbing porous membrane as described in claim 21, wherein the organic material obtained by saponification of a mixture of acetylcelluloses different from each other in acetyl value is a saponification product of a mixture of triacetylcellulose and monoacetylcellulose.

26. The nucleic acid-adsorbing porous membrane as described in claim 21, wherein the organic material obtained by saponification of a mixture of acetylcelluloses different from each other in acetyl value is a saponification product of a mixture of triacetylcellulose, diacetylcellulose and monoacetylcellulose.

27. The nucleic acid-adsorbing porous membrane as described in claim 21, wherein the organic material obtained by saponification of a mixture of acetylcelluloses different from each other in acetyl value is a saponification product of a mixture of diacetylcellulose and monoacetylcellulose.

28. The nucleic acid-adsorbing porous membrane as described in claim 19, wherein the average pore size after saponification is reduced to that before saponification.

29. The nucleic acid-adsorbing porous membrane as described in claim 28, wherein the ratio of the average pore size after saponification to that before saponification is 0.8 or less.

30. The nucleic acid-adsorbing porous membrane as described in claim 12, wherein the organic polymer having a polysaccharide structure is a regenerated cellulose.

31. The nucleic acid-adsorbing porous membrane as described in claim 11, wherein the porous membrane adsorbing the nucleic acid through the interaction involving substantially no ionic bond is a porous membrane obtained by treatment of a porous membrane of a hydrophilic group-free organic material so as to introduce a hydrophilic group into the porous membrane.

32. The nucleic acid-adsorbing porous membrane as described in claim 31, wherein the treatment of the porous membrane of a hydrophilic group-free organic material comprises binding to the porous membrane, a graft polymer chain having a hydrophilic group in the polymer chain or side chain thereof.

33. The nucleic acid-adsorbing porous membrane as described in claim 11, wherein the porous membrane adsorbing the nucleic acid through the interaction involving substantially no ionic bond is a porous membrane obtained by coating a porous membrane of a hydrophilic group-free organic material with a material having a hydrophilic group to thereby introduce a hydrophilic group into the porous membrane.

34. The nucleic acid-adsorbing porous membrane as described in claim 33, wherein the material having a hydrophilic group is an organic polymer having a hydrophilic group in the polymer chain or the side chain thereof.

35. The nucleic acid-adsorbing porous membrane as described in claim 11, wherein the porous membrane adsorbing the nucleic acid through the interaction involving substantially no ionic bond is an inorganic material where a material for forming the porous membrane itself has a hydrophilic group.

36. The nucleic acid-adsorbing porous membrane as described in claim 11, wherein the porous membrane adsorbing the nucleic acid through the interaction involving substantially no ionic bond is a porous membrane obtained by treatment of a porous membrane of a hydrophilic group-free inorganic material so as to introduce a hydrophilic group into the porous membrane.

37. The nucleic acid-adsorbing porous membrane as described in claim 36, wherein the treatment for introducing the hydrophilic group into the hydrophilic group-free inorganic material comprises binding to the porous membrane, a graft polymer chain having a hydrophilic group in the polymer chain or side chain thereof.

38. The nucleic acid-adsorbing porous membrane as described in claim 11, wherein the porous membrane adsorbing the nucleic acid through the interaction involving substantially no ionic bond is a porous membrane obtained by coating a porous membrane of a hydrophilic group-free inorganic material with a material having a hydrophilic group to thereby introduce a hydrophilic group into the porous membrane.

39. The nucleic acid-adsorbing porous membrane as described in claim 38, wherein the material having a hydrophilic group is an organic polymer having a hydrophilic group in the polymer chain or side chain thereof.

40. The nucleic acid-adsorbing porous membrane as described in claim 31, wherein the hydrophilic group is a hydroxyl group.

41. The nucleic acid-adsorbing porous membrane as described in claim 1, wherein the sample solution containing the nucleic acid, the washing solution and the recovering solution are passed, in the step (1), step (2) and step (3), respectively, through the nucleic acid-adsorbing porous membrane under pressure.

42. The nucleic acid-adsorbing porous membrane as described in claim 41, which is used in the method for separating and purification the nucleic acid,
wherein the sample solution containing the nucleic acid, the washing solution and the recovering solution is injected, in the step (1), step (2) and step (3), respectively, through a first opening of a cartridge for separating and purifying the nucleic acid, in which the cartridge comprises at least two openings including the first opening and a second opening; and
inside of the cartridge is made in a pressurized state with a pressure difference-generating apparatus attached to the first opening, so as to pass each of the sample solution containing the nucleic acid, the washing solution and the recovering solution through the porous membrane and to discharge each of the sample solution containing the nucleic acid, the washing solution and the recovering solution from the second opening.

43. A cartridge for separation and purification of nucleic acid, which comprises: a container including at least two openings including a first opening and a second opening; and a nucleic acid-adsorbing porous membrane described in claim 1, the porous membrane being received in the container.

44. The cartridge for separation and purification of nucleic acid as described in claim 43, wherein a pump as a pressure difference-generating apparatus is removably attached to the first opening of the cartridge for separation and purification of nucleic acid.

45. A kit comprising: a cartridge for separation and purification of nucleic acid, the cartridge comprising a nucleic acid-adsorbing porous membrane described in claim 1; and a reagent.

46. An apparatus for separation and purification of nucleic acid, which uses a nucleic acid-adsorbing porous membrane described in claim 1.

47. The apparatus for separation and purification of nucleic acid as described in claim 46, which is an automated apparatus automatically carrying out steps of separation and purification of nucleic acid, the steps including: adsorbing a nucleic acid in a sample solution to the nucleic acid-adsorbing porous membrane by injecting the sample solution containing the nucleic acid into a cartridge for separation and purification of nucleic acid, the cartridge comprising the nucleic acid-adsorbing porous membrane, under pressure; injecting a washing solution into the cartridge for separation and purification of nucleic acid under pressure to remove other ingredients than the nucleic acid, while the nucleic acid is adsorbed to the nucleic acid-adsorbing porous membrane; and injecting a recovering solution into the cartridge for separation and purification of nucleic acid under pressure, to desorb the nucleic acid adsorbed to the nucleic acid-adsorbing porous membrane and recover the nucleic acid together with the recovering solution;
wherein the apparatus comprises:
a mechanism of holding: the cartridge for separation and purification of nucleic acid; a waste liquor container for containing a discharged solution of the sample solution and the washing solution; and a recovery container for containing the recovering solution containing the nucleic acid;
a mechanism of feeding a pressure air into the cartridge for separation and purification of nucleic acid; and
a mechanism of separately injecting the washing solution and the recovering solution into the cartridge for separation and purification of nucleic acid.

48. The apparatus for separation and purification of nucleic acid as described in claim 47, wherein the holding mechanism comprises: a stand mounted on a body of the apparatus; a cartridge holder vertically movably supported on the stand and holding the cartridge for separation and purification of nucleic acid; and a holder for holding the waste liquor container and the recovering container at a position below the cartridge holder so that the relative position with respect to the cartridge can be exchanged.

49. The apparatus for separation and purification of nucleic acid as described in claim 47, wherein the pressure air-feeding mechanism comprise: an air nozzle for jetting pressure air from the lower edge portion; a pressure head for supporting and vertically moving the air nozzle with respect to the cartridge for separation and purification of nucleic acid held in the cartridge holder; and a positioning means provided on the pressure head, the positioning means being for positioning the cartridge for separation and purification of nucleic acid in a rack of the holding mechanism.

50. The apparatus for separation and purification of nucleic acid as described in claim 47, wherein the separately injecting mechanism comprises: a washing solution-injecting nozzle for injecting the washing solution; a recovering solution-injecting nozzle for injecting the recovering solution; a nozzle-shifting rack holding the washing solution-injecting nozzle and the recovering solution-injecting nozzle and capable of migrating in sequence over the cartridges for separation and purification of nucleic acid held by the holding mechanism; a washing solution-feeding pump for sucking the washing solution from a bottle containing the washing solution and feeding the washing solution to the washing solution-injecting nozzle; and a recovering solution-feeding pump for sucking the recovering solution from a bottle containing the recovering solution and feeding the recovering solution to the recovering solution-feeding nozzle.
